(19) United States
(12) Patent Application Publication
(10) Pub. No.: US 2009/0297429 A1
(43) Pub. Date: Dec. 3, 2009

(54) HIGH GROWTH RATE METHODS OF PRODUCING HIGH-QUALITY DIAMONDS

(76) Inventors: Yogesh K. Vohra, Hoover, AL (US); Paul A. Baker, Hoover, AL (US)

Correspondence Address: Ballard Spahr LLP, SUITE 1000, 999 PEACHTREE STREET, ATLANTA, GA, 30309-3915, US

(21) Appl. No.: 12/160,083

(22) PCT Filed: Dec. 15, 2006
(86) PCT No.: PCT/US06/47990

§ 371 Date: Apr. 27, 2009

(30) Foreign Application Priority Data
Jan. 4, 2006 (US) 60756085

(51) Int. Cl. C01B 31/06; H05H 1/24; C09D 1/00; B05C 11/00; H05H 1/46

(52) U.S. Cl. 423/446; 427/577; 106/285; 118/666; 427/575

(57) ABSTRACT

In one aspect, the invention relates to a method of producing high-quality diamond comprising the steps of providing a mixture comprising hydrogen, a carbon precursor, and oxygen; exposing the mixture to energy at a power sufficient to establish a plasma from the mixture; containing the plasma at a pressure sufficient to maintain the plasma; and depositing carbon-containing species from the plasma to produce diamond at a growth rate of at least about 10 μm/hr; wherein the diamond comprises less than about 10 ppm nitrogen. The invention also relates to the apparatus, gas compositions, and plasma compositions used in connection with the methods of the invention as well as the products produced by the methods of the invention. This abstract is intended as a safety scanning tool for purposes of searching in the particular art and is not intended to be limiting of the present invention.

### CROSS-REFERENCE TO RELATED APPLICATIONS

This application claims the benefit of U.S. Application No. 60/756,085 filed Jan. 4, 2006, which is hereby incorporated herein by reference in its entirety.

### ACKNOWLEDGEMENT

This invention was made with government support under Grant No. DE-FG03-03NA00067 awarded by the Department of Energy (DOE) and Grant No. DMR-0203779 awarded by the National Science Foundation (NSF). The U.S. government has certain rights in the invention.

### BACKGROUND

Various methods of diamond synthesis form diamond from the vapor phase using chemical vapor deposition (CVD). G. Davies, Properties and Growth of Diamond, (Inspec, London, 1994). CVD methods include hot filament CVD, flame-assisted CVD, plasma-enhanced CVD, radio frequency CVD, and microwave plasma CVD (MPCVD). These CVD processes have been shown to grow a wide variety of diamond crystals and diamond-like coatings on different substrate materials.

From the MPCVD method, large crystals have been grown, ˜10 carats in size, at high growth rates (over 100 μm/h), but with the addition of relatively high quantities of nitrogen, up to 3 standard cubic centimeters per minute (sccm). C.-S. Yan, Y. K. Vohra, H.-K. Mao, and R. J. Hemley, Proc. Natl. Acad. Sci. 99, 12523 (2002); A. Chayahara, Y. Mokuno, Y. Horino, Y. Takasu, H. Kato, H. Yoshikawa, and N. Fujimori, Diamond Relat. Mater. 13, 1954 (2004). Also, high-quality crystals have been grown without nitrogen, but at very low growth rates. A. Tallaire J. Achard, F. Silva, R. S. Sussmann, and A. Gicquel, Diamond Relat. Mater. 14, 249 (2005). In other experiments, large area, high-quality diamonds have been grown, but these are thin, and also have very low growth rates (19 nm/h). H. Watanabe, D. Takeuchi, S. Yamanaka, H. Okushi, K. Kajimura, and T. Sekiguchi, Diamond Relat. Mater. 8, 1272 (1999). Thus, a simple process for the growth of large-area, high-quality diamonds from commercially available seed crystals at reasonable growth rates without the introduction of nitrogen has not been demonstrated conclusively.

Therefore, there remains a need for methods and compositions that overcome these deficiencies and that effectively provide for the high growth rate production of high-quality diamond.

### SUMMARY

In accordance with the purpose(s) of the invention, as embodied and broadly described herein, the invention, in one aspect, relates to a method of producing high-quality diamond comprising the steps of providing a mixture comprising hydrogen, a carbon precursor, and oxygen; exposing the mixture to energy at a power sufficient to establish a plasma from the mixture; containing the plasma at a pressure sufficient to maintain the plasma; and depositing carbon-containing species from the plasma to produce diamond at a growth rate of at least about 10 μm/hr; wherein the diamond comprises less than about 10 ppm nitrogen. In a further aspect, the method can comprise a subsequent annealing step.

In a further aspect, the invention relates to a method of producing high-quality diamond comprising the steps of providing a mixture comprising hydrogen, a carbon precursor in a concentration of from about 8 vol % to about 16 vol % relative to the total volume of the mixture, and oxygen in a concentration of from about 0.4 vol % to about 0.8 vol % relative to the total volume of the mixture, wherein the oxygen is provided in a concentration of from about 5% to about 10% of the concentration of the carbon precursor; exposing the mixture to microwaves at a power of from about 1000 W to about 3000 W, thereby establishing a plasma from the mixture; containing the plasma at a pressure of from about 90 Torr to about 200 Torr; and depositing carbon-containing species from the plasma to produce diamond at a growth rate of at least about 20 μm/hr; wherein the diamond comprises less than about 10 ppm nitrogen.

In a further aspect, the invention relates to a product produced by any of the methods of the invention.

In a further aspect, the invention relates to a composition comprising hydrogen, a carbon precursor in a concentration of from about 8 vol % to about 16 vol %, and oxygen in a concentration of from about 0.08 vol % to about 3.2 vol %, wherein the concentration of each component is relative to the total volume of the composition.

In a further aspect, the invention relates to a plasma composition comprising from about 26.5 mass % to about 44.6 mass % carbon; from about 0.8 mass % to about 19.6 mass % oxygen; and from about 43.5 mass % to about 69 mass % hydrogen; wherein the % mass of each component is relative to the total mass of the composition.

In a further aspect, the invention relates to a plasma composition comprising from about 53.5 mass % to about 73.4 mass % carbon; from about 2 mass % to about 28.5 mass % oxygen; and at least about 18 mass % hydrogen; wherein the % mass of each component is relative to the total mass of the carbon, oxygen, and hydrogen.

In a further aspect, the invention relates to a plasma composition comprising from about 32.6 mass % to about 38.6 mass % carbon; from about 1 mass % to about 17.4 mass % oxygen; and at least about 44 mass % to about 66.4 mass % hydrogen; wherein the % mass of each component is relative to the total mass of the composition; wherein the composition is at a pressure of at least about 160 Torr; and wherein the plasma is generated at a power of about 2500 W.

In a further aspect, the invention relates to an apparatus for diamond production in a deposition chamber, comprising a heat-sinking holder for holding a diamond and for making thermal contact with a side surface of the diamond adjacent to an edge of a growth surface of the diamond, wherein the holder comprises a surface substantially facing a means for generating plasma, and a recess disposed within the surface and dimensioned to hold the diamond, wherein the growth surface of the diamond is positioned below the holder surface; a noncontact temperature measurement device positioned to measure temperature of the diamond across the growth surface of the diamond; and a main process controller for receiving a temperature measurement from the noncontact temperature measurement device and controlling temperature of the growth surface.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

The accompanying figures, which are incorporated in and constitute a part of this specification, illustrate several embodiments and together with the description serve to explain the principles of the invention.

FIG. 1 shows an optical micrograph showing the surface of a CVD diamond sample after growth. The small dark features are the nonepitaxial crystallites and the large flat squares are the pyramidal hillocks.

FIG. 2 shows a diagram of a twinned crystal.

FIG. 3 shows twins on the surface of a CVD diamond layer.

FIG. 4 shows a schematic of a 1.2 kW MPCVD system.

FIG. 5 shows a schematic of custom designed substrate stage in 1.2 kW CVD system.

FIG. 6 shows an energy-level diagram depicting the process of photoluminescence and a sample spectrum showing the zero-phonon line and its side bands.

FIG. 7 shows photoluminescence spectra from the crystal grown by C. S. Yan et al., showing the presence of nitrogen in the diamond.

FIG. 8 shows a Raman scattering signal from the CVD diamond surface. Note the lack of the non-diamond carbon band at 1540 cm⁻¹.

FIG. 9 shows, upper image, sample surface of diamond layer grown on a substrate that had been acid etched previous to deposition. Lower image, a sample grown using the same conditions but without the surface treatment.

FIG. 10 shows an image of the various sample holders. The threaded holders are from the 1.2 kW CVD system, and the larger ones are from the 6 kW system.

FIG. 11 shows optical micrographs showing the fabrication of an anvil: (a) the starting natural diamond, (b) as-deposited CVD layer, and (c) polished anvil.

FIG. 12 shows an optical micrograph for sample AIDA-3 showing a triangular (111) facet after deposition.

FIG. 13 shows micro-Raman spectra of three isotopically enriched diamonds and one natural isotopic abundance diamond showing Raman signal.

FIG. 14 shows a photoluminescence spectrum from the 35 μm central flat of the diamond shown in FIG. 11 c.

FIG. 15 shows a photoluminescence spectrum from the non-(100) facet of the diamond shown in FIG. 11 c.

FIG. 16 shows high-resolution photoluminescence scans of the nitrogen based 575 nm and 640 μm defect centers for diamonds of varying isotopic contents.

FIG. 17, upper panel, shows an optical micrograph of the initial substrate for sample AIDA-7. The lower panel shows the same diamond after growth.

FIG. 18 shows an AFM image of the coarse growth steps shown in FIG. 17.

FIG. 19 shows an AFM image showing the transition from coarse growth steps to fine growth steps, sample AIDA-7.

FIG. 20 shows High resolution AFM scan of the smooth outer region of the sample shown in FIG. 17.

FIG. 21 shows a sample surface covered with hillocks with very few nonepitaxial crystallites.

FIG. 22 shows a surface of CVD diamond layer with many NCs.

FIG. 23 shows growth rates as a function of methane concentration.

FIG. 24 shows photoluminescence data showing that optical defect incorporation does not increase as a function of methane concentration.

FIG. 25 shows an image of surface, which was grown on a misoriented substrate crystal. The misorientation angle is 6 degrees.

FIG. 26 shows images of diamond layers grown with 0% (upper image) and 20% (lower image) oxygen added to gas flow.

FIG. 27 shows growth rate as a function of oxygen addition to gas flow.

FIG. 28 shows an image of sample surface grown with high methane concentration (12%) and high oxygen addition (20%).

FIG. 29 shows spectra showing the reduction of impurities with the addition of oxygen.

FIG. 30 shows photoluminescence spectrum from the sample grown with nitrogen added. Note the increased size of the N-V₀ peak (1.945 eV) and the N-V peak (2.156 eV).

FIG. 31 shows three experiments demonstrating that increasing nitrogen addition increases the growth rate.

FIG. 32 shows images of diamond layers grown with the addition of nitrogen. (a) 1% nitrogen, (b) 3% nitrogen.

FIG. 33 shows a sample grown in 6 kW CVD system with 6% methane.

FIG. 34 shows a photoluminescence spectrum from sample grown in 6 kW CVD system with 6% methane. Compare to FIG. 30.

FIG. 35 shows an image of largest crystal grown in this set of experiments. Approximate total size is 3 mm height; bottom portion is seed crystal of 1.6 mm height.

FIG. 36 shows an AFM image of surface hillock with a twin at its center.

FIG. 37 shows an AFM image of surface showing relative smoothness over large area.

FIG. 38 shows a high resolution AFM image of sample with high oxygen addition, with very low surface roughness.

FIG. 39 shows an AFM image of sample grown at 850° C.

FIG. 40 shows images of same sample with: (a) reflected light, (b) transmitted light.

### DETAILED DESCRIPTION

The present invention can be understood more readily by reference to the following detailed description of aspects of the invention and the Examples included therein.

Before the present compounds, compositions, articles, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular embodiments only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which may need to be independently confirmed.

### A. Definitions

As used in the specification and the appended claims, the singular forms “a,” “an” and “the” include plural referents unless the context clearly dictates otherwise. Thus, for example, reference to “a component,” “a polymer,” or “a particle” includes mixtures of two or more such components, polymers, or residues, and the like.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

A “residue” of a chemical species, as used in the specification and concluding claims, refers to the moiety that is the resulting product of the chemical species in a particular reaction scheme or subsequent formulation or chemical product, regardless of whether the moiety is actually obtained from the chemical species. Thus, an ethylene glycol residue in a polyester refers to one or more —OCH₂CH₂O— units in the polyester, regardless of whether ethylene glycol was used to prepare the polyester. Similarly, a sebacic acid residue in a polyester refers to one or more —CO(CH₂)₈CO— moieties in the polyester, regardless of whether the residue is obtained by reacting sebacic acid or an ester thereof to obtain the polyester.

As used herein, the terms “optional” or “optionally” means that the subsequently described event or circumstance may or may not occur, and that the description includes instances where said event or circumstance occurs and instances where it does not.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valences of the heteroatoms. Unless explicitly disclosed, this disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc.

In defining various terms, “A¹,” “A²,” “A³,” and “A⁴” are used herein as generic symbols to represent various specific substituents. These symbols can be any substituent, not limited to those disclosed herein, and when they are defined to be certain substituents in one instance, they can, in another instance, be defined as some other substituents.

The term “alkyl” or “alkane” as used herein is a branched or unbranched saturated hydrocarbon group of 1 to 24 carbon atoms, for example 1 to 12 carbon atoms or 1 to 6 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dodecyl, tetradecyl, hexadecyl, eicosyl, tetracosyl, and the like. The alkyl group can also be substituted or unsubstituted. The alkyl group can be substituted with one or more groups including, but not limited to, substituted or unsubstituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol, as described herein. A “lower alkyl” group is an alkyl group containing from one to six carbon atoms.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” specifically refers to an alkyl group that is substituted with one or more halide, e.g., fluorine, chlorine, bromine, or iodine. The term “alkoxyalkyl” specifically refers to an alkyl group that is substituted with one or more alkoxy groups, as described below. The term “alkylamino” specifically refers to an alkyl group that is substituted with one or more amino groups, as described below, and the like. When “alkyl” is used in one instance and a specific term such as “alkylalcohol” is used in another, it is not meant to imply that the term “alkyl” does not also refer to specific terms such as “alkylalcohol” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, norbornyl, and the like. The term “heterocycloalkyl” is a type of cycloalkyl group as defined above, and is included within the meaning of the term “cycloalkyl,” where at least one of the carbon atoms of the ring is replaced with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, substituted or unsubstituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein.

The terms “alkoxy” and “alkoxyl” as used herein to refer to an alkyl or cycloalkyl group bonded through an ether linkage; that is, an “alkoxy” group can be defined as -OA¹ where A¹ is alkyl or cycloalkyl as defined above. “Alkoxy” also includes polymers of alkoxy groups as just described; that is, an alkoxy can be a polyether such as -OA¹-OA² or -OA¹-(OA²)ₐ—OA³, where “a” is an integer of from 1 to 200 and A¹, A², and A³ are alkyl and/or cycloalkyl groups.

The term “alkenyl” or “alkene” as used herein is a hydrocarbon group of from 2 to 24 carbon atoms with a structural formula containing at least one carbon-carbon double bond. Asymmetric structures such as (A¹A²)C═C(A³A⁴) are intended to include both the E and Z isomers. This can be presumed in structural formulae herein wherein an asymmetric alkene is present, or it can be explicitly indicated by the bond symbol C═C. The alkenyl group can be substituted with one or more groups including, but not limited to, substituted or unsubstituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol, as described herein.

The term “cycloalkenyl” as used herein is a non-aromatic carbon-based ring composed of at least three carbon atoms and containing at least one carbon-carbon double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, norbornenyl, and the like. The term “heterocycloalkenyl” is a type of cycloalkenyl group as defined above, and is included within the meaning of the term “cycloalkenyl,” where at least one of the carbon atoms of the ring is replaced with a heteroatom such as, but not limited to, nitrogen, oxygen, sulfur, or phosphorus. The cycloalkenyl group and heterocycloalkenyl group can be substituted or unsubstituted. The cycloalkenyl group and heterocycloalkenyl group can be substituted with one or more groups including, but not limited to, substituted or unsubstituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein.

The term “alkynyl” or “alkyne” as used herein is a hydrocarbon group of 2 to 24 carbon atoms with a structural formula containing at least one carbon-carbon triple bond. The alkynyl group can be unsubstituted or substituted with one or more groups including, but not limited to, substituted or unsubstituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol, as described herein.

The term “cycloalkynyl” as used herein is a non-aromatic carbon-based ring composed of at least seven carbon atoms and containing at least one carbon-carbon triple bound. Examples of cycloalkynyl groups include, but are not limited to, cycloheptynyl, cyclooctynyl, cyclononynyl, and the like. The term “heterocycloalkynyl” is a type of cycloalkenyl group as defined above, and is included within the meaning of the term “cycloalkynyl,” where at least one of the carbon atoms of the ring is replaced with a heteroatom such as, but not limited to, nitrogen, oxygen, sulfur, or phosphorus. The cycloalkynyl group and heterocycloalkynyl group can be substituted or unsubstituted. The cycloalkynyl group and heterocycloalkynyl group can be substituted with one or more groups including, but not limited to, substituted or unsubstituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein.

The term “aryl” as used herein is a group that contains any carbon-based aromatic group including, but not limited to, benzene, naphthalene, phenyl, biphenyl, phenoxybenzene, and the like. The term “aryl” also includes “heteroaryl,” which is defined as a group that contains an aromatic group that has at least one heteroatom incorporated within the ring of the aromatic group. Examples of heteroatoms include, but are not limited to, nitrogen, oxygen, sulfur, and phosphorus. Likewise, the term “non-heteroaryl,” which is also included in the term “aryl,” defines a group that contains an aromatic group that does not contain a heteroatom. The aryl group can be substituted or unsubstituted. The aryl group can be substituted with one or more groups including, but not limited to, substituted or unsubstituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein. The term “biaryl” is a specific type of aryl group and is included in the definition of “aryl.” Biaryl refers to two aryl groups that are bound together via a fused ring structure, as in naphthalene, or are attached via one or more carbon-carbon bonds, as in biphenyl.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. Microwave Plasma Chemical Vapor Deposition (MPCVD)

For the growth of homoepitaxial diamond, one method is MPCVD. This is mainly due to the design of the system, which allows the varying of many independent parameters including the chemical species, the input power, the reaction pressure, the distance of the substrate from the plasma, and the sample area. Another reason is because it provides a clean environment in which to grow diamond. In contrast, the ablation of tungsten particles from the filament in hot filament CVD, growth in atmospheric conditions in flame-assisted CVD, and the increased amount of silicon atoms from the sidewalls in radio frequency and plasma enhanced CVD create the unavoidable incorporation of impurities in the growth process.

### C. High-Quality Diamond

In the diamond gem industry, the highest quality stones can be referred to as “type IIa” diamonds, indicating that they contain less than 10 ppm nitrogen. In the jewelry business, the highest quality stones are graded D, for the most colorless, IF, meaning internally flawless, and some other nomenclature dealing with the cut of the gem. To the electronics industry, however, all of these natural stones still contain too many impurities and crystalline defects.

### D. High Growth Rate

C. S. Yan et al. first demonstrated the growth of large crystals by CVD methods using high growth rates. C.-S. Yan, Y. K. Vohra, H.-K. Mao, and R. J. Hemley, Proc. Natl. Acad. Sci. 99, 12523 (2002). This method requires the use of nitrogen (1.8 sccm) and thereby introduces impurities in the diamond, which in turn produce optical defect centers. These defect centers cause the diamond to appear yellow to the eye. Many of these nitrogen defect centers have been well characterized and have been exhaustively studied. A. M. Zaitsev, Optical Properties of Diamond: A Data Handbook, (Springer-Verlag, Berlin, 2001). Such nitrogen defect centers can interfere with the ruby fluorescence, which is used to determine the pressure inside, for example, a diamond anvil cell (DAC). Also, the electronic properties of diamond can be altered such that the use of nitrogen doped diamonds for electronic purposes is limited. A subsequent annealing process can be performed that effectively alters these defects such that the grown crystals can be used in high-pressure experiments. C.-S. Yan, H.-K. Mao, W. Li, J. Qian, Y. Zhao, and R. J. Hemley, Physica Status Solidi (a) 201, issue 4, R25 (2004). However, this is a two-step process, which requires a lot of time and large high-pressure, high-temperature diamond production equipment. Also, the annealing process does not remove the nitrogen but forces nitrogen atoms to migrate together to form platelets, which are optically neutral. S. W. Webb and W. E. Jackson, J. Mater. Res. 10, 1700 (1995). Others have reported growing high-quality crystals without nitrogen, but at growth rates of <10 μm/h. T. Teraji, S. Mitani, C. Wang, and T. Ito, J. Crystal Growth 235, 287 (2002); H. Okushi, Diamond Relat. Mater. 10, 281 (2001); D. Takeuchi, S. Yamanaka, H. Watanabe, S. Sawada, H. Ichinose, H. Okushi, and K. Kajimura, Diamond Relat. Mater. 8, 1046 (1999). Accordingly, conventional methods are prohibitively expensive for production capability, as it requires enormous amounts of time to grow relatively small amounts of diamond.

### E. Theoretical Considerations

1. Diamond Growth

Without wishing to be bound by theory, it is believed that the growth of diamond from the vapor phase occurs via migration of adsorbates on the surface. A. A. Chernov, J. Cryst. Growth, 42, 55 (1977). T. Nishinaga, in D. T. J. Hurle (ed.), Handbook of Crystal Growth, Vol. 3, Part B, (Elsevier, Amsterdam, The Netherlands, 1994), p. 667. Typically, when there is a low concentration of adsorbates on the surface, they can move to terraces on the surface where they are incorporated into the diamond lattice. The terraces are vertical steps aligned along the <110> direction that are present initially from the cut of the seed crystal, where there is typically a slight misorientation of the plane from the nominal (100) orientation. This process is generally called the “step-flow” growth, so called because the as-grown surface has fine steps on it.

Typically, when there are few terraces or there is a high concentration of adsorbates a second process overtakes the step-flow growth. The presence of too many adsorbates on the surface to allow efficient migration can cause clustering. These clusters can solidify on the surface and have more adsorbates deposited upon them. This nucleation site can begin an upward growth around which a four-sided type of terrace forms similar to the base of a pyramid. The addition of adsorbates to the sides of the pyramid can then form a wider base and the vertical growth continues to increase the height, forming more steps. This can produce pyramids that are aligned such that each side is oriented in the direction of a (110)-type plane. Without wishing to be bound by theory, it is believed that this type of growth is slower than the step-flow growth. N. Lee and A. Badzian, Diamond Relat. Mater. 6, 130 (1997).

The adsorbates can be any of several types of hydrocarbon species. The species responsible for growth in the (100) direction is hotly debated, but many researchers seem to agree on CHₓ species being the most likely types. S. P. Mehandru and A. B. Anderson, Surf. Sci. 248, 369 (1991). S. Skokov, B. Weiner, and M. Frenklach, J. Phys. Chem. 98, 7073 (1994). M. Frenklach, S. Skokov, and B. Weiner, in K. V. Ravi and J. P. Dismukes (eds.) Proceedings of the Fourth International Symposium on Diamond Materials, (The Electrochemical Society, Pennington, N.J., 1995), p. 1. There are other theories on the growth of diamond, including a mechanism by which aromatic hydrocarbon rings form on the surface and then reconstruct to bond with the sp³ carbons in the diamond lattice. K. E. Spear and M. Frenklach, Pure & Appl. Chem. 66 No. 9, 1773 (1994).

The addition of nitrogen has been shown to increase the growth rate of diamond considerably. Without wishing to be bound by theory, it is believed that this increase is due to the interaction of sub-surface nitrogen destabilizing the (2×1) reconstructed (100) surface and lengthening the dimer C—C bonds. This bond-breaking allows the process of methyl radical addition to proceed more quickly. G. Z. Cao, J. J. Schermer, W. J. P. van Enckevort, W. A. L. M. Elst, and L. J. Giling, J. Appl. Phys. 79 (3), 1357 (1996).

2. Surface Defects

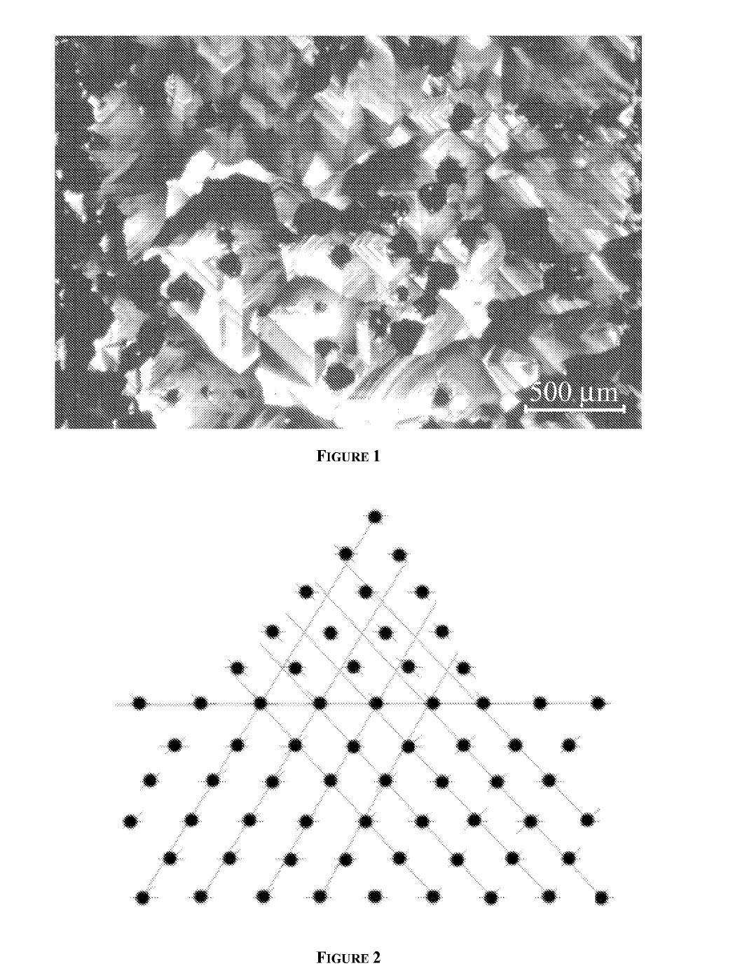

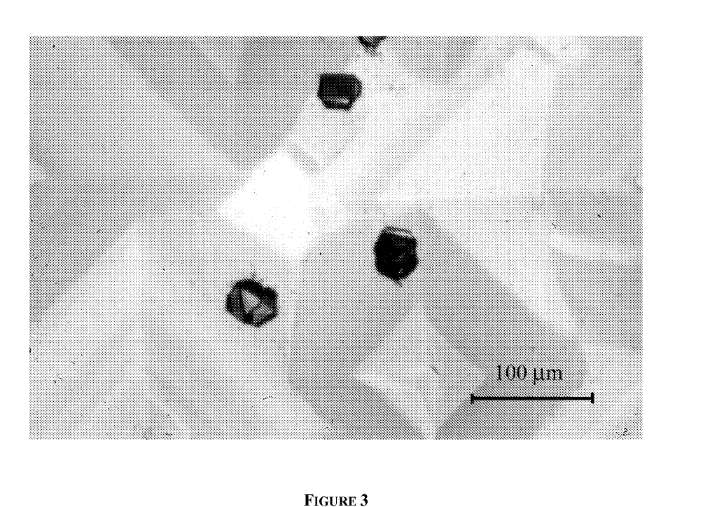

Without wishing to be bound by theory, it is believed that one barrier to the growth of homoepitaxial diamond is the interruption of the growth process by microscopic growth defects, usually referred to as nonepitaxial crystallites (NCs), as seen in FIG. 1. These include twins and non-diamond clusters. A twin is the oriented association of two or more crystals of the same phase, which are related by a geometric operation that is not a symmetry operation of the crystal structure. G. Friedel, Extract from Bullettin de la Société de l'Industrie minérale, 4^{th} series, volumes III and IV, (Sociéte de l'imprimerie Théolier J. Thomas et C., Saint-Étienne, 1904) 485. A graphical interpretation of a twin plane is shown in FIG. 2. An image of a surface with several twinned crystals can be seen in FIG. 3. The twinning is evident from the appearance of the crystal, which has a [111] orientation (based on the triangular shape), whereas the growth surface is [100] oriented.

3. Optical Defects

One challenging problem in MPCVD diamond growth is the incorporation of atomic-level defects. Typically, the most commonly incorporated atomic defect in MPCVD is the nitrogen-vacancy pair. Nitrogen can be present in ppm levels in the typical source gases used in CVD processing. However, steps can be taken to minimize these contaminants by eliminating the single greatest source of nitrogen, that which is present in the hydrogen gas. Since, in one aspect, the plasma is mostly hydrogen and the flow rate of H₂ is so high, any reduction in the amount of impurities from this source gas will provide improvement to the crystalline growth.

These improvements limit the number of possible impurities introduced into the plasma, but the addition of oxygen to the plasma has been shown to reduce the amount of nitrogen and silicon inclusions in the diamond. I. Sakaguchi, M. Nishitani-Gamo, K. P. Loh, S. Hishita, H. Haneda, and T. Ando, Appl. Phys. Lett. 73, 2675 (1998). Oxygen can preferentially etch non-sp³ bonded carbon from the diamond growth surface, improve the overall film quality, and suppress the incorporation of hydrogen in the diamond. C. J. Tang, A. J. Neves, and A. J. S. Fernandes, Diamond Relat. Mater. 13, 203 (2004). Also, the oxygen is typically not incorporated into the diamond lattice as an optical defect and has only been shown to incorporate into diamond by a very aggressive means of boiling in CrO₃ and then being hydrogen-plasma treated. Y. Mori, N. Eimori, H. Kozuka, Y. Yokota, J. Moon, J. S. Ma, T. Ito, and A. Hiraki, Appl. Phys. Lett. 60, 47 (1992).

### F. Methods for Producing High-Quality Diamond

Generally, the methods of the invention relate to producing high-quality diamond at a relatively high growth rate, for example, at a growth rate of at least about 10 μm/hr.

In one aspect, the invention relates to a method of producing high-quality diamond comprising the steps of providing a mixture comprising hydrogen, a carbon precursor, and oxygen; exposing the mixture to energy at a power sufficient to establish a plasma from the mixture; containing the plasma at a pressure sufficient to maintain the plasma; and depositing carbon-containing species from the plasma to produce diamond at a growth rate of at least about 10 μm/hr; wherein the diamond comprises less than about 2 ppm nitrogen.

In a further aspect, the method comprises the steps of providing a mixture comprising hydrogen, a carbon precursor in a concentration of from about 8 vol % to about 16 vol % relative to the total volume of the mixture, and oxygen in a concentration of from about 0.4 vol % to about 0.8 vol % relative to the total volume of the mixture, wherein the oxygen is provided in a concentration of from about 5% to about 10% of the concentration of the carbon precursor; exposing the mixture to microwaves at a power of from about 1000 W to about 3000 W, thereby establishing a plasma from the mixture; containing the plasma at a pressure of from about 90 Torr to about 200 Torr; and depositing carbon-containing species from the plasma to produce diamond at a growth rate of at least about 20 μm/hr; wherein the diamond comprises less than about 10 ppm nitrogen.

In a further aspect, the carbon precursor is methane and is provided in a concentration of from about 8 vol % to about 16 vol % relative to the total volume of the mixture; oxygen is provided in a concentration of from about 0.4 vol % to about 0.8 vol % relative to the total volume of the mixture; oxygen is provided in a concentration of about 5% of the concentration of the methane; the growth rate is at least about 30 μm/hr; and the diamond comprises less than about 2 ppm nitrogen.

In a further aspect, the carbon precursor is methane and is provided in a concentration of about 12 vol % relative to the total volume of the mixture; oxygen is provided in a concentration of about 0.6 vol % relative to the total volume of the mixture; the power is about 2500 W; the pressure is about 160 Torr; the growth rate is at least about 30 μm/hr; and the diamond comprises less than about 1 ppm nitrogen.

In a further aspect, the carbon-containing species are deposited from the plasma onto a recessed heat-sinking holder.

1. Temperature

While it is understood that the methods of the invention can be performed at any temperature capable of sustaining a plasma, in one aspect, the diamond is maintained at a temperature of from about 850° C. to about 1300° C. during deposition. For example, the diamond is maintained at a temperature of from about 900° C. to about 1250° C., from about 950° C. to about 1200° C., from about 1000° C. to about 1200° C., from about 1000° C. to about 1300° C., from about 1100° C. to about 1300° C., from about 1100° C. to about 1200° C., or from about 1200° C. to about 1300° C.

In further aspects, the diamond is maintained at a temperature of about 900° C., about 950° C., about 1000° C., about 1050° C., about 1100° C., about 1150° C., about 1200° C., about 1210° C., about 1220° C., about 1230° C., about 1240° C., about 1250° C., about 1260° C., about 1270° C., about 1280° C., about 1290° C., or about 1300° C. In a yet further aspect, the diamond is maintained at a temperature of about 1212° C. during deposition. In a yet further aspect, the diamond is maintained at a temperature of about 1050° C. during deposition.

2. Purity

Generally, the methods of the invention relate to producing high-quality diamond. In one aspect, a high-quality diamond comprises less than 10 ppm nitrogen. For example, a high-quality diamond can comprise from about 0 ppm to about 10 ppm nitrogen, from about 0 ppm to about 9 ppm nitrogen, from about 0 ppm to about 8 ppm nitrogen, from about 0 ppm to about 7 ppm nitrogen, from about 0 ppm to about 6 ppm nitrogen, from about 0 ppm to about 5 ppm nitrogen, from about 0 ppm to about 4 ppm nitrogen, from about 0 ppm to about 3 ppm nitrogen, from about 0 ppm to about 2 ppm nitrogen, from about 0 ppm to about 1 ppm nitrogen, from about 1 ppm to about 10 ppm nitrogen, from about 1 ppm to about 9 ppm nitrogen, from about 1 ppm to about 8 ppm nitrogen, from about 1 ppm to about 7 ppm nitrogen, from about 1 ppm to about 6 ppm nitrogen, from about 1 ppm to about 5 ppm nitrogen, from about 1 ppm to about 4 ppm nitrogen, from about 1 ppm to about 3 ppm nitrogen, from about 1 ppm to about 2 ppm nitrogen, from about 2 ppm to about 3 ppm nitrogen, from about 3 ppm to about 4 ppm nitrogen, from about 4 ppm to about 5 ppm nitrogen, from about 5 ppm to about 6 ppm nitrogen, from about 6 ppm to about 7 ppm nitrogen, from about 7 ppm to about 8 ppm nitrogen, from about 8 ppm to about 9 ppm nitrogen, or from about 9 ppm to about 10 ppm nitrogen. In a further aspect, a high-quality diamond can comprise less than 9 ppm nitrogen, less than 8 ppm nitrogen, less than 7 ppm nitrogen, less than 6 ppm nitrogen, less than 5 ppm nitrogen, less than 4 ppm nitrogen, less than 3 ppm nitrogen, less than 2 ppm nitrogen, less than 1 ppm nitrogen, less than 0.5 ppm nitrogen, less than 0.25 ppm nitrogen, or less than 1 ppm nitrogen.

While the purity can be measured by any method for measuring diamond purity known to those of skill in the art, one method for measuring the purity can be elemental analysis of the diamond. Methods of elemental analysis include, for example, neutron activation analysis (NAA), inductively coupled plasma mass spectrometry (ICP-MS), proton induced x-ray emission (PIXE) spectroscopy, secondary ion mass spectroscopy (SIMS), and/or x-ray absorption fine structure (XAFS).

It is understood that the methods and compositions of the invention can also relate to diamond comprising components other than nitrogen. For example, a high-quality diamond can comprise at least about 1 ppm boron, at least about 2 ppm boron, at least about 5 ppm boron, at least about 10 ppm boron, at least about 25 ppm boron, at least about 50 ppm boron, or at least about 100 ppm boron. In a further aspect, boron can be substantially absent from the diamond.

3. Growth Rate

Generally, the methods of the invention relate to relatively high growth rate production of diamond. In one aspect, the growth rate is at least about 10 μm/hr. For example, the growth rate can be at least about 15 μm/hr, at least about 20 μm/hr, at least about 25 μm/hr, at least about 30 μm/hr, at least about 35 μm/hr, at least about 40 μm/hr, at least about 45 μm/hr, at least about 50 μm/hr, at least about 55 μm/hr, or at least about 60 μm/hr.

In a further aspect, the growth rate can be from about 10 μm/hr to about 60 μm/hr, from about 10 μm/hr to about 50 μm/hr, from about 10 μm/hr to about 40 μm/hr, from about 10 μm/hr to about 30 μm/hr, from about 10 μm/hr to about 20 μm/hr, from about 20 μm/hr to about 30 μm/hr, from about 30 μm/hr to about 40 μm/hr, from about 40 μm/hr to about 50 μm/hr, from about 50 μm/hr to about 60 μm/hr, from about 30 μm/hr to about 40 μm/hr, from about 30 μm/hr to about 50 μm/hr, or from about 30 μm/hr to about 60 μm/hr.

Typically, the growth rate is expressed as a change in height per time. That is, growth rate is expressed linearly. However, in one aspect, the methods and composition of the invention can produce diamond by increasing the height of, for example, a 2.5 mm by 2.5 mm seed diamond. In such a case, the linear growth rate can be multiplied by the diamond growth surface area to produce a growth rate in terms of volume increase per time. For example, for a 2.5 mm by 2.5 mm diamond seed, about 30 μm/hr is the equivalent of about 0.1875 mm³/hr. It is understood that any measured linear growth rate can be expressed as the equivalent growth rate in terms of volume increase per time. Unless otherwise indicated, the growth rates disclosed herein are relative to a 2.5 mm by 2.5 mm seed diamond.

While the growth rate can be measured by any method for measuring growth rate known to those of skill in the art, one method for measuring the growth rate can be calculating the difference in diamond height before and after exposure to the plasma composition and dividing by the time of exposure to the plasma composition. The difference in height can be measured with, for example, calipers. In one example, a diamond seed can be exposed over 2.5 hours to the plasma compositions of the invention using the methods of the invention, resulting in a difference in height of about 87.5 μm. In this example, the growth rate is about 35 μm/hr. It is also understood, however, that the growth rate in directions other than in the (100) direction (i.e., upward or toward the plasma source) of the crystal can be different than the growth rate in the (100) direction.

Another method for measuring the growth rate can be calculating the difference in diamond mass before and after exposure to the plasma composition and dividing by the time of exposure to the plasma composition. The difference in mass can be measured with, for example, a high precision scale. In one example, a diamond seed can be exposed over 8 hours to the plasma compositions of the invention using the methods of the invention, resulting in a difference in mass of about 9.2 mg. In this example, the growth rate is about 1.15 mg/h.

It is understood that a growth rate that is expressed as a linear measurement can also be expressed as a change in volume measurement or a change in mass measurement.

4. Energy

Generally, the plasma of the methods and compositions of the invention can be provided with any energy known to those of skill in the art of establishing plasmas. As used herein, plasma means any plasma wherein energy is imparted to a gas mixture by any of the usual forms of forming a plasma. A DC arc, an RF discharge, a plasma jet, a microwave, or a combination thereof can be used as an energy source to create the plasma disclosed herein. While microwave plasma chemical vapor deposition (MPCVD) has been used to describe herein the plasma source and deposition method, this method is not limiting, and the disclosed compositions, methods, and films can be used in connection with any method for establishing a plasma known to those of skill in the art. In various aspects, the energy can be electrical (e.g., hot filament CVD), fire (e.g., flame-assisted CVD), plasma (e.g., plasma-enhanced CVD), radio waves (e.g., radio frequency CVD), and/or microwaves (e.g., MPCVD). In one aspect, the energy comprises microwaves. In a further aspect, the microwaves are generated by a 2.45 GHz microwave generator.

Generally, the plasma can be provided with any energy or power that is sufficient to establish a plasma. In one aspect, the power of the energy is at least about 1000 W. For example, the power of the energy can be at least about 1000 W, at least about 2000 W, at least about 3000 W, at least about 4000 W, or at least about 5000 W. In a further aspect, the power can be from about 1000 W to about 2000 W, from about 1000 W to about 3000 W, from about 1000 W to about 4000 W, from about 1000 W to about 5000 W, from about 1000 W to about 6000 W, from about 1000 W to about 7000 W, from about 1000 W to about 8000 W, from about 1000 W to about 9000 W, or from about 1000 W to about 10,000 W. In a yet further aspect, the power is from about 2000 W to about 3000 W, from about 2200 W to about 2800 W, from about 2400 W to about 1600 W, about 2500 W, or about 1800 W.

5. Pressure

Generally, the pressure of the compositions (e.g., mixtures or plasmas) of the invention can be any pressure sufficient for sustaining or maintaining the plasma. In one aspect, the pressure is less than atmospheric pressure. In one aspect, the pressure is at least about 90 Torr. For example, the pressure can be at least about 100 Torr, at least about 110 Torr, at least about 120 Torr, at least about 130 Torr, at least about 140 Torr, at least about 150 Torr, at least about 160 Torr, at least about 170 Torr, at least about 180 Torr, at least about 190 Torr, or at least about 200 Torr.

In a further aspect, the pressure is from about 90 Torr to about 200 Torr. For example, the pressure can be from about 100 Torr to about 200 Torr, from about 110 Torr to about 200 Torr, from about 130 Torr to about 200 Torr, from about 140 Torr to about 200 Torr, from about 150 Torr to about 200 Torr, from about 100 Torr to about 190 Torr, from about 100 Torr to about 180 Torr, from about 100 Torr to about 170 Torr, from about 100 Torr to about 160 Torr, from about 100 Torr to about 150 Torr, from about 140 Torr to about 180 Torr, or about 160 Torr.

6. Gas Compositions

In one aspect, the methods of the invention can employ the gas compositions of the invention. Typically, the mixtures used in connection with the invention can comprise hydrogen, a carbon precursor, and oxygen. In one aspect, nitrogen is substantially absent from the mixture. Optionally, the mixture can further comprise a carrier. Optionally, the mixture can further comprise a source of boron. Suitable sources of boron include diborane (B₂H₄), trialylboranes, trihaloboranes, boronic acids, and boronic esters.

In one aspect, the invention relates to a composition comprising hydrogen, a carbon precursor in a concentration of from about 8 vol % to about 16 vol %, and oxygen in a concentration of from about 0.08 vol % to about 3.2 vol %, wherein the concentration of each component is relative to the total volume of the composition.

a. Carbon Precursor

In one aspect, the carbon precursor comprises at least one of methane, a C₂ to C₁₂ alkane, ethene, a C₃ to C₁₂ alkene, acetylene, a C₃ to C₁₂ alkyne, carbon dioxide, benzene, toluene, xylene, a C₁ to C₁₂ alcohol, graphitic particles, a carbon cluster of at least C₂, buckminsterfullerene, a higher fullerene, a carbon nanotube, a carbon nanoparticle, or a mixture thereof. In a further aspect, the carbon precursor comprises at least one of methane or acetylene. In one aspect, the carbon precursor is a gas. In a further aspect, the carbon precursor is volatized within a gaseous carrier.

In a further aspect, the carbon precursor is provided in a concentration of from about 8 vol % to about 16 vol % relative to the total volume of the mixture. For example, the carbon precursor can be provided in a concentration of from about 9 vol % to about 13 vol %, from about 10 vol % to about 14 vol %, from about 10 vol % to about 12 vol %, from about 12 vol % to about 14 vol %, of about 8 vol %, of about 9 vol %, of about 10 vol %, of about 11 vol %, of about 12 vol %, of about 13 vol %, of about 14 vol %, of about 15 vol %, or of about 16 vol %.

In one aspect, the carbon precursor is provided in a concentration of about 12 vol % relative to the total volume of the mixture.

b. Carrier

In one aspect, the mixture further comprises an optional carrier gas. That is, the carrier does not have to be included in the mixture. In various aspects, the carrier gas comprises at least one of helium, neon, argon, krypton, xenon, or radon or a mixture thereof.

c. Oxygen

In one aspect, the oxygen is provided in a concentration of from about 0.08 vol % to about 3.2 vol % relative to the total volume of the mixture. For example, oxygen can be provided in a concentration of from about 0.1 vol % to about 3 vol %, from about 0.1 vol % to about 2.5 vol %, from about 0.1 vol % to about 2 vol %, from about 0.1 vol % to about 1.5 vol %, from about 0.1 vol % to about 1 vol %, from about 0.1 vol % to about 0.5 vol %, from about 0.5 vol % to about 3 vol %, from about 0.5 vol % to about 2.5 vol %, from about 0.5 vol % to about 2 vol %, from about 0.5 vol % to about 1.5 vol %, from about 0.5 vol % to about 1 vol %, from about 1 vol % to about 3 vol %, from about 2 vol % to about 3 vol %, from about 1 vol % to about 2 vol %, of about 1 vol %, of about 1.5 vol %, of about 2 vol %, of about 2.5 vol %, of about 3 vol %, of about 0.6 vol %, of about 0.7 vol %, of about 0.8 vol %, of about 0.9 vol %, of about 1.1 vol %, of about 1.2 vol %, of about 1.3 vol %, or of about 1.4 vol %. In a further aspect, oxygen is provided in a concentration of from about 0.8 vol % to about 1.6 vol % or from about 0.4% to about 0.8% relative to the total volume of the mixture.

In one aspect, oxygen is provided in a concentration of from about 1% to about 20% of the concentration of the carbon precursor. For example, oxygen can be provided in a concentration of from about 5% to about 10%, from about 10% to about 15%, from about 5% to about 15%, from about 5% to about 20%, from about 10% to about 15%, from about 15% to about 20%, from about 10% to about 20%, from about 1% to about 5%, from about 1% to about 10%, or from about 1% to about 15% of the concentration of the carbon precursor.

In a further aspect, oxygen can be provided in a concentration of about 1%, of about 2%, of about 3%, of about 4%, of about 5%, of about 6%, about 7%, of about 8%, of about 9%, of about 10%, of about 11%, of about 12%, about 13%, of about 14%, of about 15% of about 16%, of about 17%, of about 18%, about 19%, or of about 20% of the concentration of the carbon precursor.

d. Hydrogen

Generally, the mixtures comprise hydrogen. In one aspect, the hydrogen is provided from a cylinder of compressed hydrogen gas. In a further aspect, hydrogen is provided by hydrolysis of water.

In one aspect, hydrogen is provided in the mixture in an amount that balances the total gas concentration to 100%. In a further concentration, less than an amount of hydrogen that balances the total gas concentration to 100% is present.

### G. Plasma Compositions

Generally, the invention also relates to plasma compositions produced by the methods of the invention. The plasma compositions of the invention can be used to deposit high-quality diamond at a relatively high growth rate.

In one aspect, the invention relates to a plasma composition comprising from about 26.5 mass % to about 44.6 mass % carbon; from about 0.8 mass % to about 19.6 mass % oxygen; and from about 43.5 mass % to about 69 mass % hydrogen; wherein the %/mass of each component is relative to the total mass of the composition. In a further aspect, the balance of the composition consists essentially of hydrogen. In a further aspect, the composition further comprises a carrier. In one aspect, nitrogen is substantially absent from the composition.

In one aspect, the invention relates to a plasma composition comprising from about 53.5 mass % to about 73.4 mass % carbon; from about 2 mass % to about 28.5 mass % oxygen; and at least about 18 mass % hydrogen; wherein the %/mass of each component is relative to the total mass of the carbon, oxygen, and hydrogen. In a further aspect, carbon is present at about 37.2 mass %, the oxygen is present at about 4.95 mass %, and the hydrogen is present in at least about 22 mass %. In a yet further aspect, at least a portion of the hydrogen is derived from methane gas. In a yet further aspect, at least a portion of the hydrogen is derived from hydrogen gas.

In one aspect, the composition comprises from about 32.6 mass % to about 38.6 mass % carbon; from about 1 mass % to about 17.4 mass % oxygen; and at least about 44 mass % to about 66.4 mass % hydrogen; wherein the %/mass of each component is relative to the total mass of the composition; wherein the composition is at a pressure of at least about 160 Torr; and wherein the plasma is generated at a power of about 2500 W. In a further aspect, carbon is present at about 37.2 mass %, oxygen is present at about 4.95 mass %, and hydrogen is present at about 57.9 mass %.

1. Carrier

In one aspect, the plasma composition of the invention can further comprise a carrier. That is, a carrier can be optionally used in the composition. The carrier can be, for example, at least one of helium, neon, argon, krypton, xenon, or radon or a mixture thereof. In one aspect, a carrier is substantially absent from the composition. In one aspect, nitrogen is substantially absent from the composition.

2. Carbon

Generally, the plasmas of the invention comprise carbon. In one aspect, carbon is present at about 32.6 mass % to about 38.6 mass % for example, at about 37.2 mass %, for example, at about 35.6 mass % to about 37.2 mass %.

In a further aspect, at least a portion of the carbon is derived from at least one of methane, a C₂ to C₁₂ alkane, ethene, a C₃ to C₁₂ alkene, acetylene, a C₃ to C₁₂ alkyne, carbon dioxide, benzene, toluene, xylene, a C₁ to C₁₂ alcohol, graphitic particles, a carbon cluster of at least C₂, buckminsterfullerene, a higher fullerene, a carbon nanotube, a carbon nanoparticle, or a mixture thereof. In a further aspect, at least a portion of the carbon is derived from methane gas. In a yet further aspect, at least a portion of the carbon is derived from acetylene gas.

3. Oxygen

Generally, the plasmas of the invention comprise oxygen. In one aspect, oxygen is present at about 1 mass % to about 17.4 mass %, for example, at about 9 mass % to about 16.6 mass % or at about 4.95 mass %. In a further aspect, at least a portion of the oxygen is derived from oxygen gas. In a yet further aspect, at least a portion of the carbon and at least a portion of the oxygen are derived from carbon dioxide.

4. Pressure

Generally, the pressure of the compositions (e.g., mixtures or plasmas) of the invention can be any pressure sufficient for sustaining or maintaining the plasma. In one aspect, the pressure is less than atmospheric pressure. In one aspect, the pressure is at least about 90 Torr. For example, the pressure can be at least about 100 Torr, at least about 110 Torr, at least about 120 Torr, at least about 130 Torr, at least about 140 Torr, at least about 150 Torr, at least about 160 Torr, at least about 170 Torr, at least about 180 Torr, at least about 190 Torr, or at least about 200 Torr.

In a further aspect, the pressure is from about 90 Torr to about 200 Torr. For example, the pressure can be from about 100 Torr to about 200 Torr, from about 110 Torr to about 200 Torr, from about 130 Torr to about 200 Torr, from about 140 Torr to about 200 Torr, from about 150 Torr to about 200 Torr, from about 100 Torr to about 190 Torr, from about 100 Torr to about 180 Torr, from about 100 Torr to about 170 Torr, from about 100 Torr to about 160 Torr, from about 100 Torr to about 150 Torr, from about 140 Torr to about 180 Torr, or about 160 Torr.

5. Energy

Generally, the plasma of the methods and compositions of the invention can be provided with any energy known to those of skill in the art of establishing plasmas. As used herein, plasma means any plasma wherein energy is imparted to a gas mixture by any of the usual forms of forming a plasma. A DC arc, an RF discharge, a plasma jet, a microwave, or a combination thereof can be used as an energy source to create the plasma disclosed herein. While microwave plasma chemical vapor deposition (MPCVD) has been used to describe herein the plasma source and deposition method, this method is not limiting, and the disclosed compositions, methods, and films can be used in connection with any method for establishing a plasma known to those of skill in the art. In various aspects, the energy can be electrical (e.g., hot filament CVD), fire (e.g., flame-assisted CVD), plasma (e.g., plasma-enhanced CVD), radio waves (e.g., radio frequency CVD), and/or microwaves (e.g., MPCVD). In one aspect, the energy comprises microwaves. In a further aspect, the microwaves are generated by a 2.45 GHz microwave generator.

Generally, the plasma can be provided with any energy or power that is sufficient to establish a plasma. In one aspect, the power of the energy is at least about 1000 W. For example, the power of the energy can be at least about 1000 W, at least about 2000 W, at least about 3000 W, at least about 4000 W, or at least about 5000 W. In a further aspect, the power can be from about 1000 W to about 2000 W, from about 1000 W to about 3000 W, from about 1000 W to about 4000 W, from about 1000 W to about 5000 W, from about 1000 W to about 6000 W, from about 1000 W to about 7000 W, from about 1000 W to about 8000 W, from about 1000 W to about 9000 W, or from about 1000 W to about 10,000 W. In a yet further aspect, the power is from about 2000 W to about 3000 W, from about 2200 W to about 2800 W, from about 2400 W to about 1600 W, or about 2500 W.

### H. Apparatus

Generally, the methods and compositions of the invention can be used in connection with any plasma deposition apparatus known to those of skill in the art. In one aspect, the apparatus is a microwave plasma deposition apparatus. An exemplary apparatus that can be used in connection with the invention is described in the Experimental section.

In one aspect, the invention relates to an apparatus for diamond production in a deposition chamber, comprising a heat-sinking holder for holding a diamond and for making thermal contact with a side surface of the diamond adjacent to an edge of a growth surface of the diamond, wherein the holder comprises a surface substantially facing a means for generating plasma, and a recess disposed within the surface and dimensioned to hold the diamond, wherein the growth surface of the diamond is positioned below the holder surface; a noncontact temperature measurement device positioned to measure temperature of the diamond across the growth surface of the diamond; and a main process controller for receiving a temperature measurement from the noncontact temperature measurement device and controlling temperature of the growth surface.

1. Temperature Gradient

Generally, the heat sinking holder serves to provide uniform cooling across the diamond and the growth face of the diamond during formation. In one aspect, all temperature gradients across the growth surface are less than 100° C., less than 50° C., less than 40° C., less than 30° C., less than 20° C., or less than 10° C.

2. Recessed Holder

In one aspect, the heat sinking holder comprises a recess disposed within the surface and dimensioned to hold the diamond, wherein the growth surface of the diamond is positioned below the holder surface. That is, the diamond can be contacted on all sides, except the growth surface, by the heat sinking holder. As a result, cooling through heat transfer can be optimized.

a. Dimensions

Generally, the Heat Sinking Holder can be Provided at any Desired Size. In One aspect, the holder is provided with a recess disposed therein dimensioned to hold a diamond of from about 0.25 carat to about 4 carats, for example, from about 0.5 carat to about 3 carats, from about 1 carat to about 2 carats, or from about 2 carat to about 3 carats in size. In a further aspect, only a growth surface of the diamond is exposed.

b. Materials

Generally, the heat sinking holder can comprise any metal with a melting point higher than the temperature of the plasma. For example, the holder can comprise molybdenum or a titanium, zirconium, molybdenum (TZM) alloy. In a further aspect, the heat-sinking holder comprises molybdenum.

3. Cooling

Generally, the heat sinking holder cools the diamond during deposition. In one aspect, the diamond is cooled through contact heat transfer by the holder material. In a further aspect, the heat-sinking holder further comprises a means for cooling. The means for cooling can be any means for cooling metals that is known to those of skill in the art and is compatible with the deposition method and apparatus. For example, the holder can be liquid- or gas-cooled (e.g., a water line) to further remove heat from the system. As a further example, refrigeration can be used to further cool the holder.

### I. Experimental

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### 1. MPCVD SYSTEM

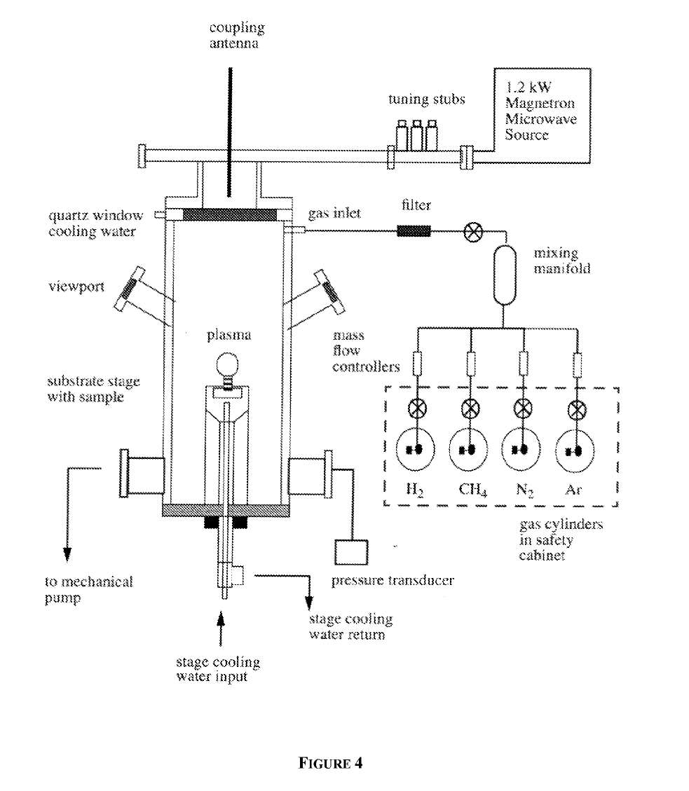

In one aspect, five main systems comprise the MPCVD system. They are: the vacuum chamber and the associated vacuum components required to achieve vacuum and control pressure in the chamber, the microwave source and components connecting it to the chamber, the coolant system, the computer control system, and the system which connects the various gases to the chamber. The complete system is represented schematically in FIG. 4.

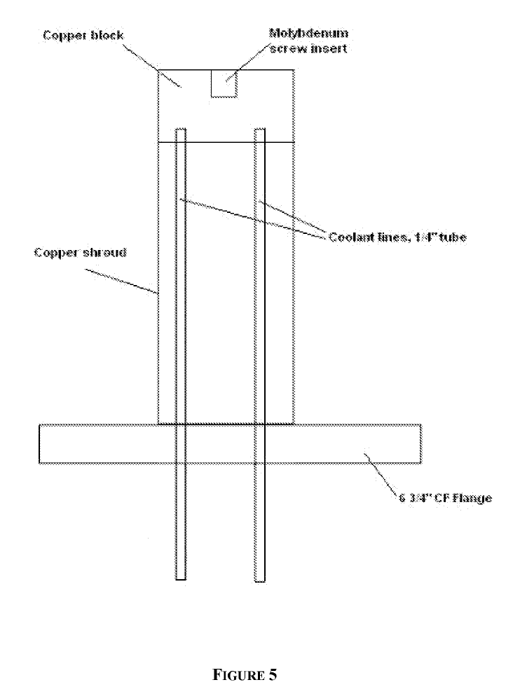

The vacuum chamber is a custom design with three viewports, a top flange, and a bottom flange. The viewports are used for in situ monitoring of the plasma with a pyrometer. The top flange is a quartz window through which the microwave radiation enters the chamber. The bottom flange is removable for insertion of the sample. Mounted on the inside of the bottom flange is the refrigerated sample stage. This stage consists of a copper housing inside which is a cooling line which conducts coolant through a copper piece. This copper piece holds the molybdenum substrate holder. A schematic of this stage can be seen in FIG. 5. The vacuum pump is a Varian Tri-scroll 300 with a throttle valve that controls the pressure in the chamber via a pressure controller.

The microwave source is a Sairem 1.2 kW, 2.45 GHz power supply and magnetron attached to a waveguide. The waveguide is designed to support a TE₁₀ mode of microwaves. The waveguide is then coupled to an antenna that is designed to convert the TE₁₀ mode into a TM₀₁ mode. The microwaves can be tuned so that the microwave energy density is greatest at the height of the diamond. Reflected power is monitored and kept below 10 W during microwave operation, this way the microwave power is coupled optimally to the plasma.

There are three main components of the coolant system. One is a water line that runs through the microwave power supply and also runs through the chamber walls. A Thermo Neslab RTE-740 refrigerates the stage via a cooling line that is inserted through the bottom flange. The third component is a Neslab RTE-110 refrigeration unit that circulates ethylene glycol through tubing which attaches to the upper quartz window. The viewport has a quartz-to-metal seal that is a lead-silver solder that has a melting point of about 350° C. so it has to be cooled due to the microwave heating of the window. The coolant in the refrigeration unit is set to maintain a coolant temperature of 10° C.

The computer control system consists of a computer with Labview software on it and a data acquisition card, which receives input from the two-color infrared pyrometer and has a serial connection to the microwave power supply. The computer takes temperature measurements from the pyrometer, which is focused on the diamond substrate, and adjusts the microwave power using a PID control loop to maintain a constant substrate temperature. It also records the temperature as a function of time.

The source gas system is set up such that the gas cylinders, which are housed in explosion-proof safety cabinets, are connected by ¼″ stainless steel tubing to MKS type. 1170 mass flow controllers (MFCs), which regulate the rate of gas flow. The output of each MFC is connected to a mixer and then introduced into the chamber. In addition, a shutoff valve is located just before the mixed gas enters the chamber. The MFCs are connected to a programmable control unit that operates each of the units. These flow controllers have different ranges depending on the amount of gas being used. The hydrogen controller is a high flow-rate controller because it is the main gas used in the plasma. The oxygen is a low flow-rate controller because it is an additive to the plasma. The range of the controller also determines the error in the flow rate, which for this model is 1% of full scale. Laboratory safety requires the use of a hydrogen leak detector where hydrogen is used, and a detector is permanently installed next to the CVD system.

Since the sample heating is achieved by proximity to the plasma, one of the most critical components of the system is the molybdenum holder in which the diamond seed crystal is held, which is a 1.25 cm diameter, ˜3 cm long, threaded piece of high purity molybdenum. The length of the screw determines how far the sample will be inserted into the plasma. Different pieces can be machined to fit different sample sizes. Since the holder is refrigerated externally, contact between the holder and the sample is very important. More contact will result in greater thermal transfer and will require greater microwave power to achieve higher sample temperatures.

In order to minimize impurities from the source gases, the standard high-grade hydrogen (99.999% H₂) tank normally used for CVD experiments has been replaced with a Parker-Balston H₂-500 hydrogen gas generator with specifications claiming better than 99.99999% hydrogen production. The other gases are all grade 5 (99.999%) or better. The vacuum backing pump was also changed from a rotary vane pump to a Varian Tri-Scroll 300 pump after it had been determined that the rotary vane pump was allowing oil vapor to backflow into the system. This oil vapor was another source of impurities in the system. Also, the system is designed such that the quartz window is located relatively far from the plasma; this minimizes the etching of silicon by the plasma.

The 6 kW CVD system is very similarly constructed, in that it has the same basic systems but a slightly different implementation of each. The microwave source is a 6 kW power supply with a waveguide, but the antennae is designed on a different mode. The TE₁₀ mode is converted to a TM₀₁₂ mode. This mode is supposed to provide a more even heat distribution over a larger area. The stage is capable of holding up to a 10 cm sample. The microwave entrance is a quartz bell jar instead of a window. This bell jar maintains the vacuum integrity while allowing a less obstructed view of the sample stage. The cooling systems are composed of a recirculating bath chiller for the microwave source and some parts of the chamber, and a pressurized air system that cools the bell jar. The gas, computer, and temperature sub-systems are essentially the same as the 1.2 kW CVD system.

### 2. ANALYTICAL TOOLS

Analytical techniques used in connection with the present invention include optical microscopy, x-ray diffractometry (XRD), micro-Raman spectroscopy, low-temperature (80 K) photoluminescence (PL), and atomic force microscopy (AFM). A Leica macroscope with continuously variable magnification from 6.3× to 32× and 10× eyepieces was used to provide optical inspection of the morphology. The light is transmitted through the microscope and reflects from the surface through a quarter-wave plate. This provides a high contrast view of the surface only. For image capture, a Nikon film camera is attached to the microscope with an extension tube and a 1.25× converter. Also, a digital camera can be attached for faster image capture, providing 340×240 pixel color images.

XRD can provide information about the crystalline quality of the diamond by measuring the full width at half maximum (FWHM) of the diamond (004) peak. These rocking curve measurements are accomplished by setting the detector angle at the 2θ° value (119.9°) for diamond and varying the incident x-ray angle (denoted ω by Phillips) by ±3° of θ. The amount of spread about the exact value for 2θ° provides an indication of the crystallinity of the sample. Single crystal samples should have extremely narrow peaks, natural type IIa diamonds can have values over 0.1°, but HPHT type Ib crystals have lower values of around 0.003-0.004°. S. Fujii, Y. Nishibayashi, S. Shikata, A. Uedono, and S. Tanigawa, Appl. Phys. A 61, 331 (1995). T. Bauer, M. Schreck, H. Sternschulte, and B. Stritzker, Diamond Relat. Mater. 14, 266 (2005).

Also used was a Dilor 0.6 m x-y spectrometer and a liquid nitrogen cooled 1024-line CCD array. The spectrometer has several gratings that can be used for various levels of resolution. The 1200-groove/mm grating is normally used for micro-Raman studies and the 150-groove/mm grating is used for the PL studies. There are several excitation sources available; the primary one is an Argon ion, capable of emitting wavelengths of 514.5 nm, 488 nm, and several shorter wavelengths but with low intensity. Another source is the Krypton laser with an excitation wavelength of 647.1 nm. Due to the typical sample sizes used in the lab, the laser beam is focused through a parallel optics microscope. This focuses the laser spot and ensures that the volume from which the detected signal will be measured is very small.

Low-resolution spectra were taken using the 150 lines/mm holographic grating with an observed FWHM resolution of 4 meV at photon energies of 2.0 eV (1.2 nm at 620.0 nm). High-resolution spectra were taken with the 1,200 lines/mm holographic grating with a typical resolution of 0.3 meV (2.5 cm⁻¹) at 2.0 eV. In high resolution the spectral peak positions could be determined to 0.8 cm⁻¹ (0.1 meV) based upon calibration spectra from argon, neon, and mercury emission tubes.

Since Raman scattering involves the interaction of phonons in the lattice with the incident photons, the intensity of the Raman signal can be used to gauge the amount of order in the lattice. The average value for the Raman mode in diamond is 1332 cm⁻¹ away from the excitation wavenumber. Because diamond is a highly symmetric lattice, the first order Raman signal is usually very strong, thus the second order Raman (a two-phonon interaction) gives an even better indication of the crystalline order. The second order Raman mode is more of a band that starts around 2100 cm⁻¹ and has a sharp cut-off around 2600 cm⁻¹. A standard measure of diamond quality sometimes used in gemological testing is to ratio the height of the second order Raman signal to the background intensity. A value for very high-quality diamond is about two.

The diamonds were mounted on a MMR Technologies refrigeration stage in a vacuum system where temperatures were varied between 80 K and 320 K. This stage uses the Joule-Thomson effect to cool a sample inside a small vacuum chamber to 80 K. The vacuum in the small chamber was maintained at a pressure of 1.3 Pa or less. The chamber has a small window through which the incident laser beam can hit the sample. For the work on the flat diamond plates, a special 50× objective from Mitutoyo is used because of its very long working distance (about 2 cm). For the isotopically enhanced designer diamond work, a long working distance 25× objective was used. The depth of focus of this lens was set to view to a depth of about 50 μm using a confocal pinhole of about 300 μm. By reducing the thermal noise the PL is enhanced greatly.

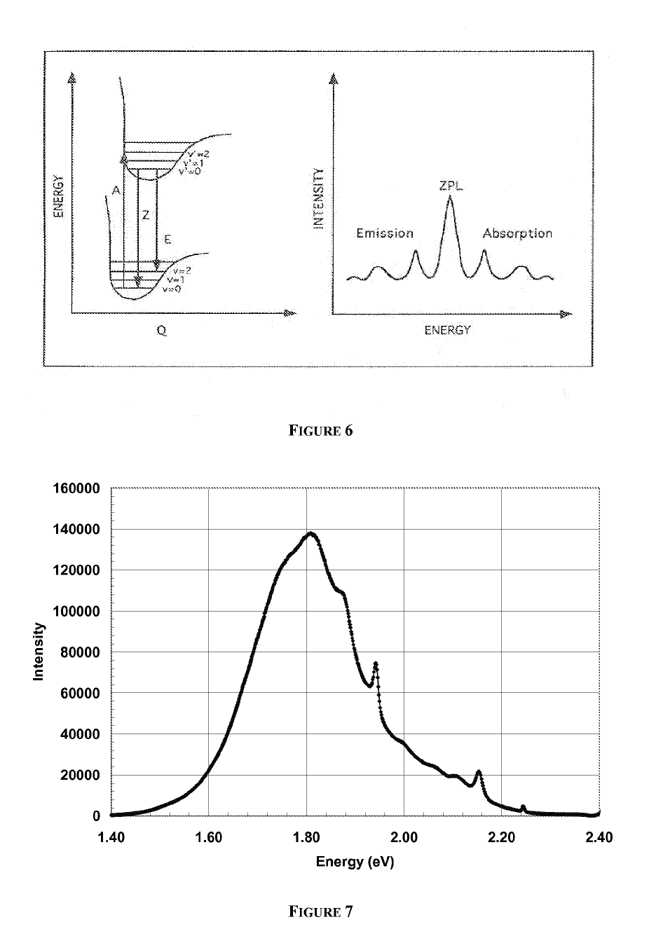

The photoluminescence arises from defects in the crystal that act as donor levels in the band gap. Photoluminescence is a very sensitive analytical technique that can detect impurities down in the ppm range. The photoluminescence peaks typically are accompanied by several sidebands that are the luminescence energy minus a multiple of the phonon energy. The primary, most intense signal is called the zero-phonon line (ZPL) and the sidebands are the one-phonon line, two-phonon line and so on. An illustrative figure of the energy level diagram for photoluminescence and a spectrum of the ZPL and its side bands is in FIG. 6.

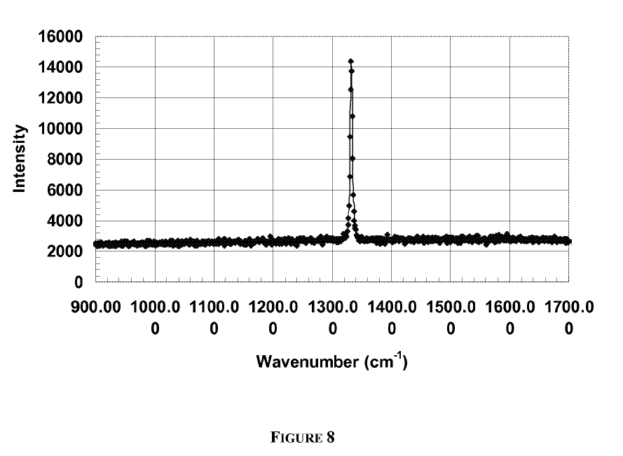

Typically, in CVD diamond the most significant impurities are nitrogen, silicon and hydrogen. These can be incorporated in different ways. The nitrogen typically is incorporated as substitutional atoms with an adjacent vacant lattice site. This is called the N-V₀ pair and has a PL energy value of 1.945 eV. The other main defect center in diamond is also nitrogen related but not as well understood. This particular defect is still under investigation. The prevailing theory is that the defect center is comprised of a vacancy adjacent to a substitutional nitrogen atom, but the vacancy has a trapped electron. It does, however, have a very well known PL signature of 2.156 eV. The silicon defect is a cluster of four substitutional silicon atoms in the diamond lattice; it has an energy value of 1.68 eV. The silicon comes from the quartz window in the CVD chamber. FIG. 7 shows the PL from a heavily nitrogen doped CVD diamond. C.-S. Yan, Y. K. Vohra, H.-K. Mao, and R. J. Hemley, Proc. Natl. Acad. Sci. 99, 12523 (2002). Occasionally, in the growth of diamond using CVD there is the incorporation of non-diamond carbon in the lattice. This appears as a broad band around 1540 cm⁻¹. However, experiments conducted using oxygen typically show that the incorporation of non-diamond carbon is very low. A sample graph demonstrating this is FIG. 8.

A Veeco Explorer AFM with multiple scanners for different levels of resolution was used. The 100 μm and the 2 μm scanners were used to obtain images of the surface. These provide a maximum area for scanning of 100×100 μm and 2×2 μm, respectively. The maximum height differential on the 100 μm scanner is 10 μm and the 2 μm scanner has a maximum of 0.8 μm. The stated horizontal resolution of the tip is 15 nm, and the vertical resolution is on the order of angstroms. Editing of the scans was performed on the SPMlab software provided with the AFM. The roughness values are calculated internal to the system by the use of an area roughness function. This calculates the overall roughness of a selected area. This value is somewhat dependent on the size of the scan, in that the larger an area is, the more likely it is that the variation in height will be greater.

### 3. DEPOSITION PROCEDURE

Preparation typically involves etching a substrate holder with plasma containing 10% oxygen and 90% hydrogen. This cleaning process is conducted with a substrate (in this case, the molybdenum holder) temperature of 850° C. for an hour. This cleans any deposited carbon from the molybdenum. After this, the chamber is thoroughly cleansed with acetone and the substrate diamond is placed in the holder. The chamber is sealed and then pumped overnight. This produces a base pressure of 0.5 Pa. This is done to minimize the nitrogen and water vapor in the chamber. The gases are left on such that the lines are continuously pressurized, thereby reducing the likelihood of nitrogen or water vapor in the source gases. Each of the gases is closed off so that there is no leak into the chamber from the mass flow controllers.

The deposition process is typically started with hydrogen plasma to bring the substrate close to the deposition temperature. The other process gases, typically CH₄ and O₂, are turned on and the system is allowed to stabilize at a particular temperature and pressure. The microwave power and the pressure are adjusted to ensure that the substrate is at the desired temperature. After this, manual control over the microwave power is turned over to the Labview program, which varies the power to keep the substrate at the set point temperature. Throughout the process, the reflected power is kept low by tuning the microwave cavity. After the desired deposition time has passed, all gases except for the hydrogen are turned off. The Labview control program has a built-in function that will lower the forward power at a steady rate until the plasma is extinguished. During this steady shutdown, the pressure is lowered manually and the reflected power is kept to a minimum by adjusting the tuning screws. This procedure is carried out in a time interval of seven minutes. This prevents the deposited diamond from becoming etched by the hydrogen plasma and does not thermally shock the diamond.

### 4. ISOTOPIC ENRICHMENT OF DIAMOND ANVILS

Diamond deposition was made with a microwave plasma chemical vapor deposition system using gas flow rates of 490 sccm for H₂, 10 sccm for the combined methane (¹²CH₄ and ¹³CH₄), and 1 sccm of O₂. The deposition chamber pressure was about 0.5 Pa prior to introduction of the plasma gases and was held at about 12 kPa during deposition. The temperature of the diamond anvil was monitored with a pyrometer and was maintained at 1212° C. by regulating the microwave power in the range of 1000 W to 1100 W. Diamond growth rates of up to 10 μm per hour have been achieved. Deposition times were four hours for all diamond anvils except the 0.4 molar deposition experiment, which lasted only two hours. R. S. Peterson, P. A. Baker, S. A. Catledge, Y. K. Vohra, and S. T. Weir, J. Appl. Phys. 97, 073504 (2005).

The diamond growth on the anvils varies with the geometry of the anvil surface. The anvils were made from one-third carat, type Ia, brilliant-cut diamonds with a (100) oriented flat polished on the culet, opposite and parallel to the diamond's table. The anvils are oriented to within 2 degrees of the <100> direction. The natural abundance diamond anvils containing 98.9 at % ¹²C and 1.1 at % ¹³C were used as substrates in the present series of experiments. Table I shows the details on the seven independent experiments that were carried out to produce Altered Isotope Diamond Anvils (AIDA) along with a natural abundance diamond as a control designated as L162.

### 5. LARGE DIAMOND PLATE EXPERIMENTS

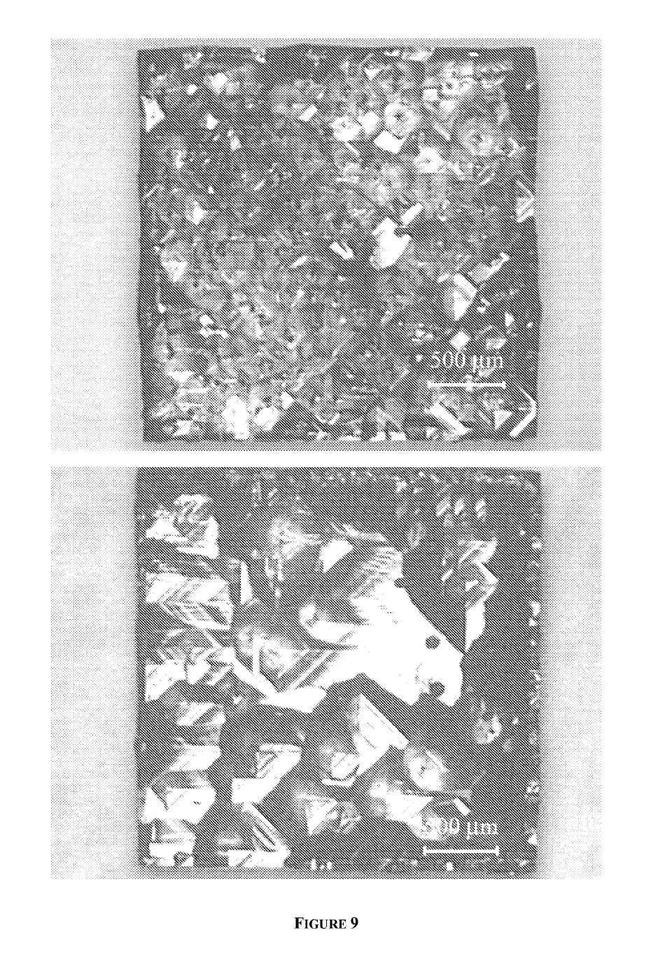

Before the series of experiments testing the chemistry and operating conditions were performed, an experiment was conducted to see if the hillocks were related to the initial substrate surface contaminants. The diamond seed was placed in a 1:1 mixture of nitric and sulfuric acid and boiled under a chemical hood for 45 minutes. After this, a water rinse and methanol rinse was performed and the seed was placed in the CVD chamber. This plate was deposited upon for eight hours with a gas flow mixture of 287 sccm hydrogen, 12 sccm methane, and 1.2 sccm oxygen. This sample is shown in FIG. 9, with a sample using the same conditions without the surface treatment. As can be clearly seen, the hillocks are still present.

There were three distinct series of experiments performed on the 1.2 kW CVD system, each of which was conducted to study a particular aspect of the CVD deposition process. All of the experiments performed are listed in Table 2. The three series on the 1.2 kW CVD system were set up so that only one parameter varied. The first series was chosen because methane is the only carbon source in the feedgas and this was presumed to be the most important factor in the growth rate. Other methane studies have been reported, but none of them cover the region of concentrations chosen here or at the temperature of ˜1200° C. A. Tallaire J. Achard, F. Silva, R. S. Sussmann, and A. Gicquel, Diamond Relat. Mater. 14, 249 (2005). H. Watanabe, D. Takeuchi, S. Yamanaka, H. Okushi, K. Kajimura, and T. Sekiguchi, Diamond Relat. Mater. 8, 1272 (1999). T. Teraji, S. Mitani, C. Wang, and T. Ito, J. Crystal Growth 235, 287 (2002). Thus, a set of experiments was conducted using gas mixtures of 2%, 4%, 6%, 8%, 10%, and 12% methane to total gas flow. Also added in each deposition was 10% oxygen relative to methane flow. For instance, a 6% methane deposition would mean a flow of 12 sccm methane, 1.2 sccm oxygen, and 187 sccm hydrogen for a total of 200 sccm gas flow. In each experiment the pressure was maintained at 21.3 kPa. The temperature for each was fixed at 1170° C. The deposition length for all experiments was eight hours, during which the power was allowed to vary between 1000 W and 1160 W. The power is not allowed to drop below 1000 W because the energy density becomes too low to deposit high-quality diamond.

The next set of experiments involved the addition of oxygen to the growth process. Oxygen has been reported to have beneficial effects on the deposition process by removing graphite from the surface and preventing the incorporation of silicon in the diamond. However, a comprehensive study of the effects of oxygen addition has not been performed for the high-pressure, high-temperature, homoepitaxial diamond growth conditions. Thus, a series of depositions were performed where all parameters were held constant except the concentration of oxygen in the gas mixture. The methane concentration for the oxygen series was chosen to be 6% based on the quality of results of the methane concentration study. The oxygen concentrations chosen were 0% (none added, as a control), 5%, 10%, and 20%. The percentage of oxygen is relative to the methane flow, so if a flow rate of 12 sccm methane is used, a flow of 1.2 sccm oxygen would be an addition of 10%. Since the addition of oxygen is also known to reduce the growth rate, it was assumed that a deposition with greater than 20% oxygen addition would not be useful since the growth rate would be very low.

The last series of experiments on the 1.2 kW CVD system involved the addition of nitrogen. The addition of nitrogen has been found to accelerate the growth rate, in some cases by greater than threefold. C.-S. Yan, Y. K. Vohra, H.-K. Mao, and R. J. Hemley, Proc. Natl. Acad. Sci. 99, 12523 (2002). However, the effect of nitrogen on the surface morphology and its ability to increase the growth rate, have not been studied in great detail. The experiments carried out were a deposition with 1% nitrogen, relative to the methane flow, and a 3% nitrogen addition deposition.

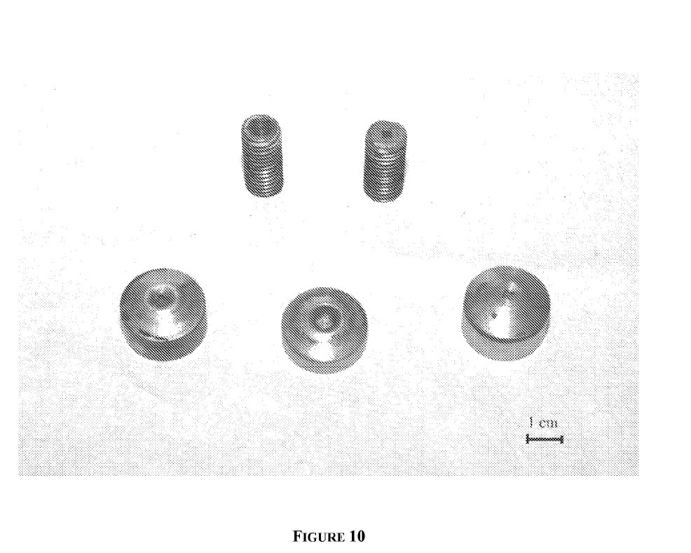

After these experiments were concluded and the analysis had been conducted, one more parameter had yet to be tested, which was outside the capability of the 1.2 kW CVD system. Most of the research groups reporting on the growth of homoepitaxial diamond are using a CVD system capable of producing around 6 kW of microwave power. Thus, the experiments described above are not in direct comparison to those of the other groups. It became apparent also that the difference in power was providing a different morphology at the same pressure and temperature. For example, a diamond deposition was performed at a substrate temperature of 850° C., in an attempt to replicate the type of growth obtained by Tallaire et al. A. Tallaire J. Achard, F. Silva, R. S. Sussmann, and A. Gicquel, Diamond Relat. Mater. 14, 249 (2005). At this substrate temperature, they have obtained a high-quality layer of diamond with no hillocks and some regions of what they call step bunching, which appears to be a form of step flow growth. Thus an experiment was performed using similar conditions to see if the same morphology could be produced at a lower power. One result of this experiment was that a very dissimilar morphology was obtained. It was then concluded that some experiments on the 6 kW CVD system were needed. Three more experiments were performed with this system using two new molybdenum holders made for this system. These holders are shown in FIG. 10. The first experiment was a standard deposition with 6% methane to total gas flow, 5% oxygen to methane gas flow, an operating pressure of 21.3 kPa, and a substrate temperature of 1170° C. This deposition was run for twelve hours. The second deposition was at the same conditions except that the substrate temperature was only 850° C. It also was run for twelve hours. In the third experiment a high methane concentration of 12% to total gas flow was used with 5% oxygen to methane gas flow at a substrate temperature of 1200° C.

Three other experiments were conducted in an attempt to obtain a large diamond layer; that is, a greater than 500 micron layer. The first experiment was run for 48 hours using the standard 6% methane chemistry with 10% oxygen on the 1.2 kW CVD system. The second experiment, also run on the 1.2 kW CVD system, was with a high methane concentration of 12% with a high concentration of oxygen, 20%. This experiment was run for a total time of 24 hours. A final experiment was performed for 60 hours using the 12% chemistry with 5% oxygen addition, this time using the 6 kW CVD system. The oxygen was reduced slightly to increase the growth rate.

### 6. RESULTS

a. Optical Defects

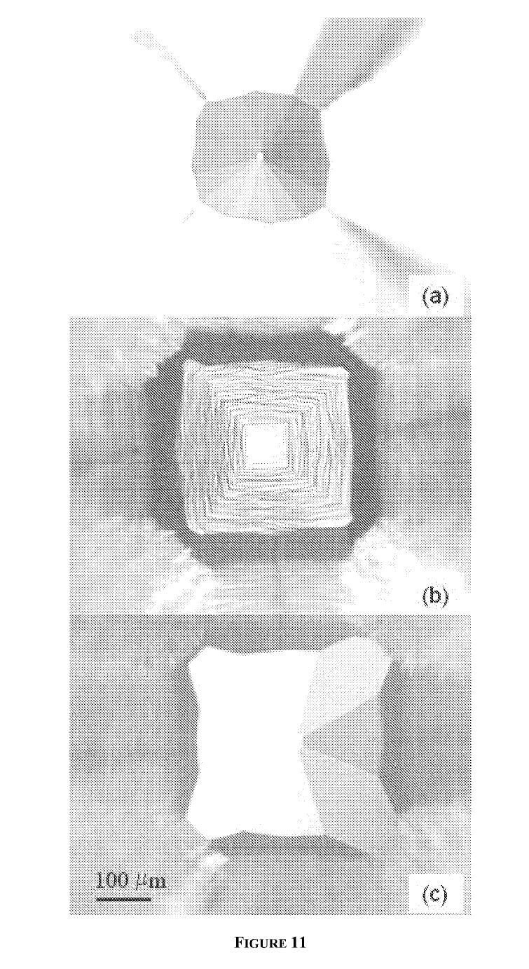

For the experiments 0.3-carat diamond anvils with (100) orientation were used as a substrate for growing the AIDA samples (Table 1). Sample AIDA-1 was grown with 41 at % ¹³C isotope. FIG. 11 shows the optical micrographs for sample AIDA-2, with 83 at % ¹³C, in the sequence of original diamond (FIG. 11 a), post-CVD deposition (FIG. 11 b), and the polished, final anvil (FIG. 11 c). The central flat in the pre-deposition FIG. 11 a is an (100) oriented surface with a diameter of about 10 μm and polished facets with a bevel angle of 10°. The diamond growth in FIG. 11 b shows a characteristic square morphology after CVD growth before the polishing step. The diamond AIDA-2 was polished with a flat area 35 μm in diameter that is parallel to the original (100)-oriented table with angled facets of 8.5° and is a typical bevel design used in ultra high pressure experiments (FIG. 11 c).

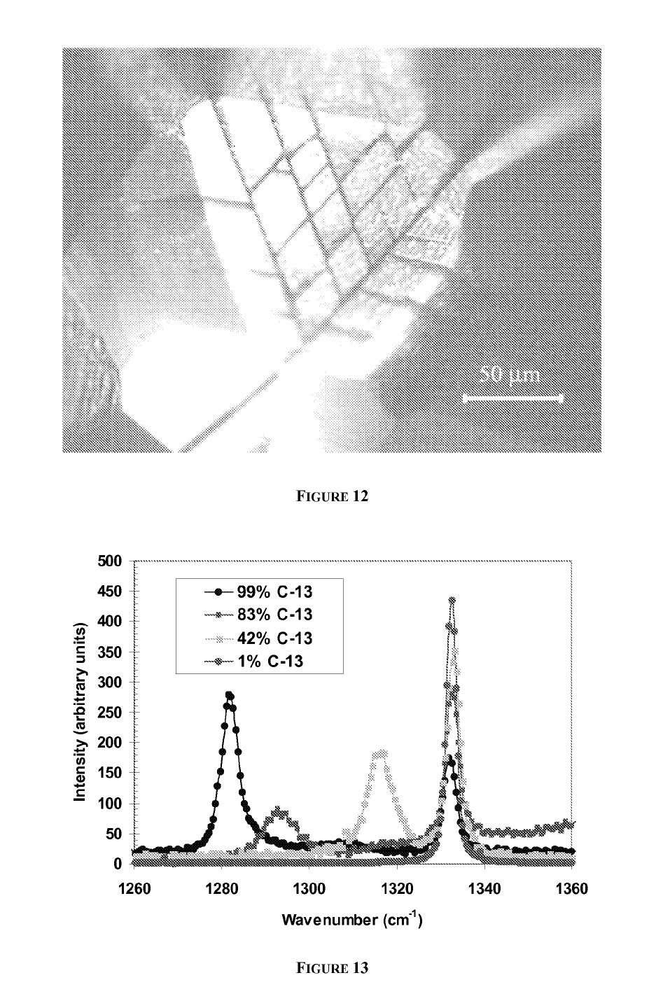

The sample AIDA-3, that showed the poorest diamond growth as shown in FIG. 12, started with a diamond anvil with a (100) oriented flat region and 20° beveled facets on the culet. The deposited diamond has regions of high stress, deduced from the splitting of emission lines in the fluorescence spectra. The crystal cracked immediately when polishing began, in a pattern characteristic of (111) planes (see FIG. 12). C. J. Chu, M. P. D'Evelyn, R. H. Hauge, and J. L. Margrave, J. Appl. Phys. 70, 1695 (1991). Micro-Raman scattering spectra from several positions on this diamond growth, before and after cracking, showed only isotopic shifts characteristic of 100% ¹³C composition. The triangular shaped (111) growth facet on a starting (100) oriented surface is attributed to the formation of twins on the surface and the outgrowth of one of these twins to encompass the entire surface. These growth instabilities leading to (111) facet need to be avoided during fabrication of designer diamond anvils, as these surfaces are prone to cracking during subsequent polishing.

The identification of the ¹³C molar fraction of carbon deposited as diamond was determined by measuring the Raman-scattered laser light. Natural diamonds (1.1% ¹³C) have a first-order Raman peak at 1332.4 cm⁻¹. S. A. Solin and A. K. Ramdas, Phys. Rev. B 4, 1687 (1970). As the molar fraction of the ¹³C increases, the Raman peak decreases monotonically to 1,281 cm⁻¹ for 100% ¹³C diamond. These changes in the Raman peaks shift as a function of the ¹³C molar fraction have been measured. K. C. Hass, M. A. Tamor, T. R. Anthony, and W. F. Banholzer, Phys. Rev. B45, 7171 (1992). H. Hanzawa, U. Umemura, Y. Nisida, H. Kanda, M. Okada, and M. Kobayashi, Phys. Rev. B54, 3793 (1996). M. P. D'Evelyn, C. J. Chu, R. H. Hange, and J. L. Margrave, J. Appl. Phys. 71, 1528 (1992). David Schiferl, Malcolm Nicol, Joseph M. Zaug, S. K. Sharma, T. F. Cooney, S.-Y. Wang, Thomas R. Anthony, and James F. Fleisher, J. Appl. Phys. 82, 3256 (1997). D. Behr, J. Wagner, C. Wild, and P. Koidl, Appl. Phys. Lett. 63, 3005 (1993). Empirical equations relating the energy of the Raman scattering peak to the ¹³C molar fraction have been found. These empirical results were used to determine the isotopic mix of the deposited diamond. All these empirical equations give molar fractions within the experimental uncertainties of the measured peak positions, as shown in Table 1. R. S. Peterson, P. A. Baker, S. A. Catledge, Y. K. Vohra, and S. T. Weir, J. Appl. Phys. 97, 073504 (2005).

A composite of the Raman spectra from all four isotopic mixtures studied for this experiment is shown in FIG. 13. These spectra were taken at high spectral resolution with a 25× objective or a 100× objective. The 100× objective has a smaller depth of field than the 25× objective and this smaller depth of field enhances the Raman peak from the deposited diamond relative to the original natural diamond. The Raman peak energies were determined from a fit of a symmetric, pseudo-Voigt function to the observed Raman peaks using the FITYK software.

A summary of the measured Raman energies and FWHM values are given in Table 1. The widths are as measured and are not corrected for the spectrometer resolution. The measurements of the widths and positions of Raman peaks from 20 diamond slices and shards purchased from Harris International, Ltd. gave an average peak energy and width equal to the peak in the 1.2% ¹³C diamond and the original natural diamond anvils.

The ¹³C molar fractions calculated from measured Raman shifts closely mirrors the ¹³CH₄ and ¹²CH₄ flow rates as measured by an MFC, as seen in Table 1. The systematic deviation between the MFC-measured flow rates and the Raman-measured molar fractions probably represents the limits of flow controller calibrations and the gas correction factors employed in flow settings.

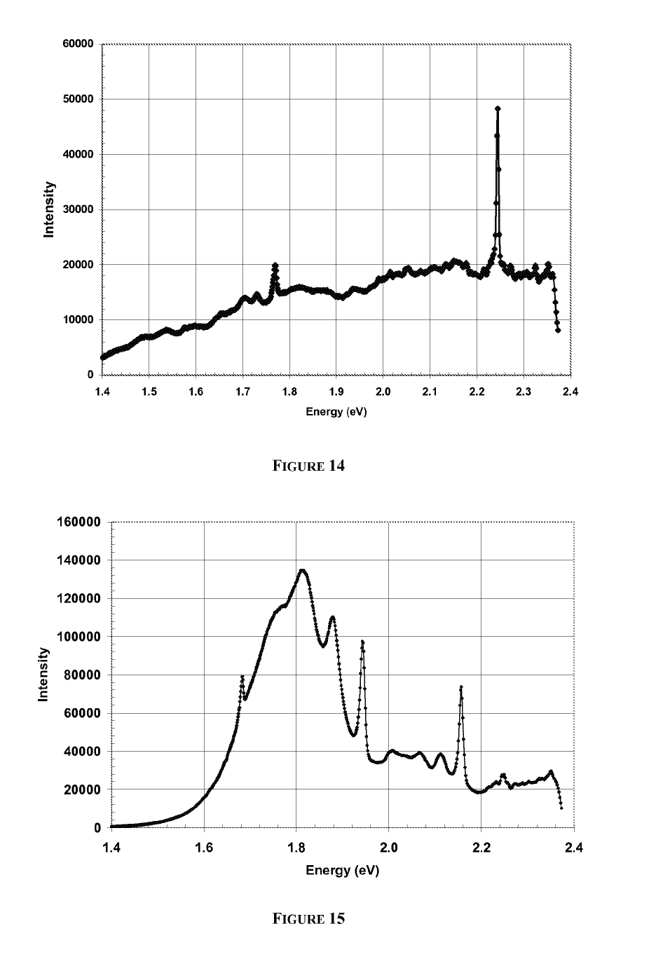

Most of the micro-PL spectra at low temperatures were taken using a 514.5 nm focused beam from an Argon-ion laser with a focal spot diameter of about 30 μm. Well-studied PL spectral lines, the zero-phonon line (ZPL) from N-V₀ defects at nominal energies of 1.945 eV (640 nm), and 2.156 eV (575 nm) are visible in PL spectra from the deposited diamond in FIGS. 14 and 15. These ZPL peaks are quite prominent at 80 K, although they are plainly identifiable at room temperature. The 1.945 eV and 2.156 eV peaks are observed primarily from non-(100) growth regions, such as the general surface of the octahedral growth and the growth on the 10° and 20° facets.

Almost no trace of these ZPL peaks from N-V defects is seen from the CVD diamond on the polished flats or from the original diamonds (compare FIGS. 14 and 15). This is especially important for diamonds used in DACs, which need to have a low-fluorescence yield from laser excitation when ruby fluorescence or Raman spectroscopy measurements are carried out on samples in the DAC. In fact, the general fluorescence spectra from the flat on the polished culet for the 1.2% ¹³C CVD diamond and the 83% ¹³C CVD diamond are comparable to the overall fluorescence from the original natural diamonds. These original diamonds were selected for their low fluorescence yield and large second-order Raman peak intensity as compared to background fluorescence.

The spectral positions of these ZPL peaks should shift with the change in the ¹³C molar fraction. A. T. Collins, G. Davies, H. Kanda, and G. S. Woods, J. Phys. C: Solid State Phys. 21, 1363 (1988). This is due in part to the change in the volume of the lattice that depends upon the ¹³C molar fraction. H. Hanzawa, U. Umemura, Y. Nisida, H. Kanda, M. Okada, and M. Kobayashi, Phys. Rev. B54, 3793 (1996). Yamanaka, S. Morimoto, and H. Kanda, Phys. Rev. B 49, 9341 (1994). There is also a shift in the ZPL energy due to lattice modes that involve carbon. This was estimated by Collins et al. from the temperature dependence of the ZPL energy. A. T. Collins, G. Davies, H. Kanda, and G. S. Woods, J. Phys. C: Solid State Phys. 21, 1363 (1988). Since both ZPL corrections are additive to the ¹²C ZPL energies at 1.945 eV and 2.156 eV, it is reasonable to assume that the ZPL energies for ¹³ C molar fractions between 0 and 1 will lie between the ZPL energies for the pure isotopes. The results of high-resolution spectral measurements of the ZPL energies of the NV defect centers are given in Table 3, along with the experimental and theoretical results from Collins et al.

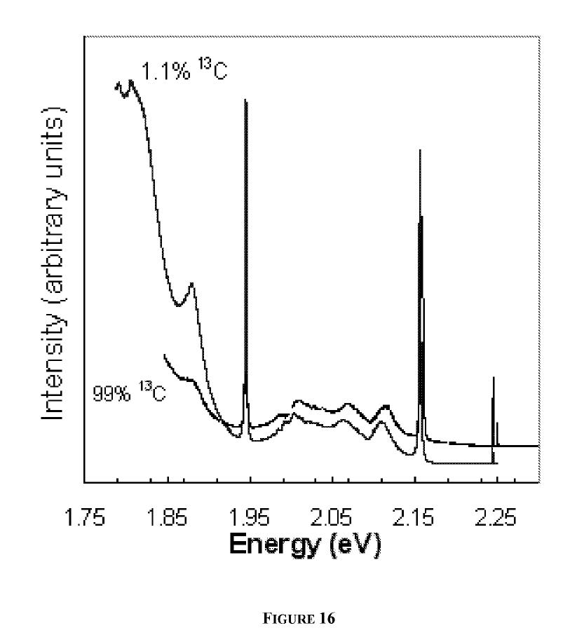

Only ZPLs with narrow, symmetric line shapes measured at temperatures of 80 K were used in Table 3. A graph of the photoluminescence of a 1.2% ¹³C diamond grown homoepitaxially on a natural diamond is contrasted with the photoluminescence of a 99% ¹³C homoepitaxial layer in FIG. 16. The graph is a composite of individual high-resolution spectra from CCD detector made by adjusting their intensities to join the spectra smoothly and produce spectra over an extended energy range.

The ZPL energies from the 1.2% ¹³C diamond deposition are the same, within statistics, as those reported in the literature for natural abundance diamonds. Yamanaka, S. Morimoto, and H. Kanda, Phys. Rev. B 49, 9341 (1994). The 575 nm defect ZPL energy is 2.1558 eV and the 640 nm defect ZPL energy is 1.9454 eV. For the 99% ¹³C diamond, the results presented here are close to those of Collins et al. for the 575 nm line. Collins et al. report a +3 meV shift compared with the measured average +2.5 (1.0) meV shift. The ZPL energies measured from the 41% and 83% ¹³C diamonds lie between those of the 1.2% and the 99% diamonds.

The 640 nm ZPL did not shift in the 99% ¹³C spectra, as can be seen in FIG. 6. Shifts between 0 to 1 meV were measured in the 640 nm ZPL for the 41% ¹³C, 83% ¹³C, and other ¹³C diamonds. Collins et al. observed a shift of +2.1 meV.

The peaks to the low energy side of the ZPLs are the single phonon sidebands (see FIG. 7). These are vibronic sideband replicas of the ZPL. A. T. Collins and G. Davies, J. of Lumin. 40 &41, 865 (1988). Collins et al. argue that these single phonon sideband energies from the ZPL should scale approximately as the square root of the ratio of the reduced masses, 0.96. Measurements of the sideband energies agree with those of Collins et al. and are found in Table 3. These sideband energies are due to the local structure of the defect and the reduced mass should depend upon the relative number of ¹²C and ¹³C atoms associated with the defect.

As the ¹³C molar fraction increases, the probability for the nitrogen-vacancy defect to be coupled with more ¹³C atoms should decrease the reduced mass. In addition to a shift in the energy, this may result in an increase in the sideband width and an asymmetry to the peak shape. This shift was observed in the sidebands of the 575 nm and the 640 nm defects in the 41% and 83% ¹³C diamonds.

Not all of the spectral measurements of ZPL lines gave a single peak for the ZPLs, which may be the result of stress in the CVD deposition at the site of the measured defect. Broadening and asymmetry can also result from a local stress. Davies and Hamer, Proc. R. Soc. Lond. A. 348,285 (1976). Raman lines will also broaden and shift when the site of the measurement is stressed. No systematic shifts in the Raman lines were observed here greater than the uncertainty in the measurements of about 0.5 cm⁻¹. In view of the complex geometry of the modified, brilliant-cut diamond used as the substrate for the homoepitaxial growth, regions of localized stress are observed in the CVD layer. There are also areas of little or no observed stress, as the narrow linewidths of the Raman and ZPLs indicate.

In addition to the 640 nm and 575 nm ZPLs discussed above, ZPLs were observed at 1.77 eV and 1.68 eV. The 1.77 eV ZPL with vibronic sidebands is seen in FIG. 14. This ZPL is known from observations in cape yellow diamonds and is observed in some of the diamond substrates used in the experiments. A. M. Zaitsev, Optical Properties of Diamond: A Data Handbook, (Springer-Verlag, Berlin, Heidelberg, 2001), pp. 188-224. This defect center does not appear to be created in the CVD process and is observed only in areas of thin CVD deposition on diamond substrates with the defect. The 1.68 eV ZPL in FIG. 6 is associated with silicon. This center is created when silicon, etched by the plasma from the quartz windows of the vacuum system, is incorporated into the CVD layer. Designer diamond anvils can be made without 1.68 eV and 1.77 eV by selecting a substrate diamond without the 1.77 eV ZPL and by controlling the CVD plasma to minimize the quartz window etching. No ZPLs were observed that could be attributed to tungsten defects from the designer diamond anvil microprobe or molybdenum defects from the mount that holds the diamond in the CVD plasma.

b. Surface Morphology

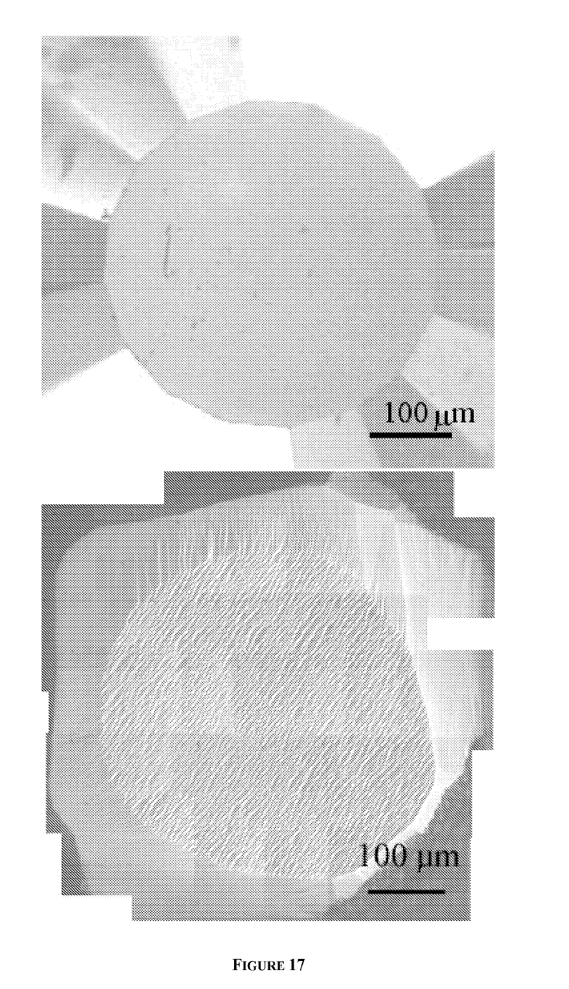

Isotopically pure ¹³C sample AIDA-7 was selected for a detailed AFM study to understand the surface morphology of the epitaxial diamond layers. The AIDA-7 sample was rinsed ultrasonically for 2 minutes in methanol and characterized by optical microscopy as having two distinct morphologies. One region has a rough appearance with step-flow growth on the (100) oriented tip and the second region appears to be very smooth. The upper panel in FIG. 17 shows the pre-deposition surface with diamond flat size of 400 μm in diameter. The lower panel in FIG. 17 shows the same surface after growth at identical magnification for a direct comparison between the pre- and post-deposition surfaces. The picture in the lower panel in FIG. 17 was obtained after superimposing 40 high-resolution digital images to display the growth steps on the surface. Surrounding the rough central area was a relatively smooth region, some areas of which had no discernable features as determined from optical microscopy. AFM was used to study both of these regions. A software level process was applied to the data to remove sample tilt and allow better image contrast/detail. Other software processing involved shadowing to better illuminate features of interest, but this had no effect on feature dimensions.

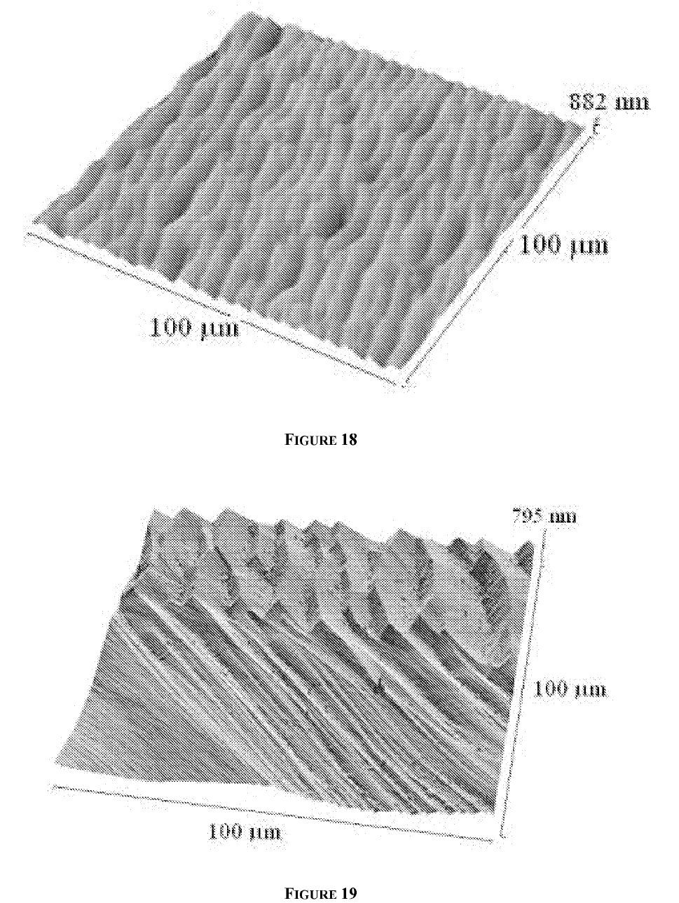

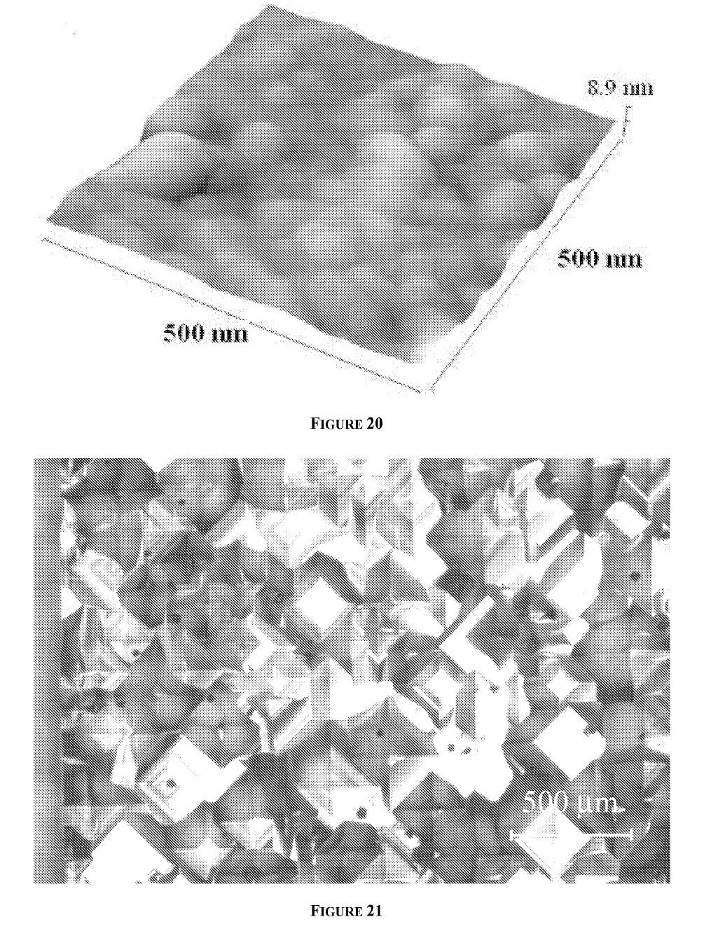

FIG. 18 shows a 100 μm square area taken from the rough area of the anvil. Nearly parallel growth steps with average spacing of 4.2 μm and average step height of 305 nm are present. The area was found to have R_{Rms}=117 nm. An investigation of a 20 μm square region taken from the rough area shows some irregularity of the step edges. FIG. 19 shows a 50 μm square area showing the transition from rough to smooth areas. The transition in step period, height, and orientation is abrupt. The parallel lines that define the step orientation angle changes by approximately 45°. This indicates a boundary between <100> and <110> growth directions. The steps on the smooth side have about 1.2 μm spacing and 40 nm height, and a roughness R_{RMS}=35 nm. Imaging on the visibly smooth areas of the anvil, scattered secondary particles up to 6 nm in height were detected, resulting in an overall area roughness of only R_{RMS}=1.3 nm. AFM studies were also carried out on the other optically smooth areas shown in FIG. 17. One such smooth area is shown in FIG. 20, as a 500 nm square region that resembles a polycrystalline morphology often seen in nanostructured diamond growth (rounded nodules). These nodules are from about 50 to 150 nm in diameter, and up to 9 nm in height. AFM studies clearly demonstrate a clear transition from the rough growth steps near the central (100) growth area to the outer smooth areas on the non-(100) growth surfaces.

C. Large Area Diamond Growth

One way to increase the growth rate is to raise the pressure. This can increase the concentration of gas species without changing other variables significantly. One problem that can arise when trying to change the growth conditions is that an increase in pressure requires a decrease in the power to produce the same deposition temperature. This combination of an increase in pressure and a decrease in temperature can cause the plasma ball to have a smaller diameter. Experiments showed that the growth is not uniform when using high pressures due to the decreased size of the plasma ball. This resulted in samples with a widely varied surface morphology indicating an uneven thermal gradient across the surface. These experiments were conducted with a molybdenum holder that had a wide, flat area upon which the sample was placed. This type of holder (referred to as an “open type”) has been found to produce higher growth rates than one that has contact on the sides of the sample, a closed type holder. A. Chayahara, Y. Mokuno, Y. Horino, Y. Takasu, H. Kato, H. Yoshikawa, and N. Fujimori, Diamond Relat. Mater. 13, 1954 (2004). Subsequent experiments with a closed type, for example a heat-sinking holder as disclosed herein, showed that much more uniform growth occurs as a result of the more uniform thermal contact with the holder. This new holder provided the correct growth conditions of 21.3 kPa, ˜1050 W, and ˜1200° C. The sample holders are also shown in FIG. 10.

Typically, pyramidal hillocks formed under all conditions used, except for when nitrogen was added and in the high power experiment. The hillocks, which form evenly on the surface, do not always impede the growth in the (100) direction. In fact, hillocks are typically the predominant form of growth in the (100) direction, at high temperature. They also grow together to form fewer and larger hillocks. The growth stops when a non-epitaxial crystallite grows over the hillocks. The NCs eventually cover a significant portion of the surface and this slows down the growth on the (100)-surface. There are growth conditions where the NCs are much suppressed and are almost non-existent. One such example can be seen in FIG. 21, where the surface is covered by hillocks with almost no sign of NCs originating from the surface.

The shape, size, and distribution of the hillocks can change dramatically depending on the growth conditions. There appear to be two different kinds of NCs. The kinds that become dominant in the higher methane concentration depositions are generally rough and angular. Most are shaped like a starfish but with six points instead of five. A close-up image of one is in FIG. 22. These crystallites grow such that they do not become encased by the homoepitaxial growth. Thus the presence of these types of NCs will signal the end of the high-quality deposition. The other types of NCs are contact twins with varying orientations. These are very regular in shape and their orientation can be readily identified. In FIG. 3, several of these can be seen. They also appear to grow slower than the surrounding homoepitaxial growth and could potentially become encased.

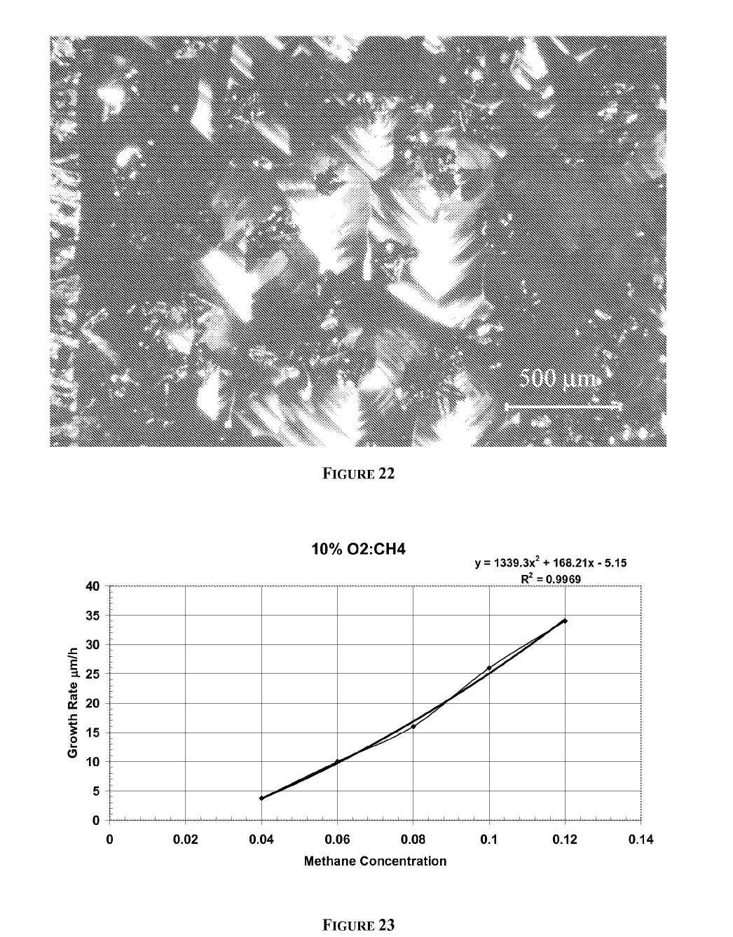

The series of experiments on the effect of methane concentration revealed that the general shape of the growing diamond and the types of microstructures formed during the diamond growth are basically the same for the range of methane concentrations used. The relative sizes and numbers of these microstructures vary according to how much methane is used. As the methane concentration is increased the growth rate increases, as can be seen in FIG. 23. With this increase in growth rate, however, comes an increase in the size of NCs.

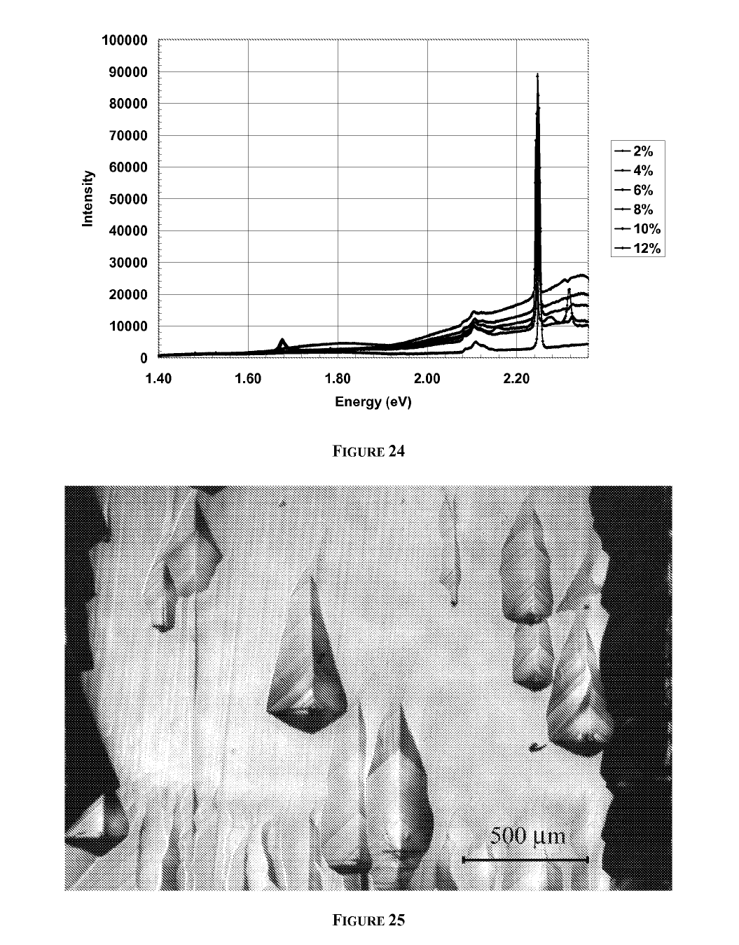

The photoluminescence data gathered from the samples grown in the methane series show that there is low incorporation of defects in the diamond. Data was taken in the center and in the corner to test for differences in distribution. The incorporation of defects is very low in the center and moderately low in the corners. The spectra were taken away from surface defects and on relatively flat areas of the surface. As can be seen from FIG. 24, the defects do not increase as a function of methane concentration, except for the center at 2.32 eV. This center has been attributed to an incorporation of boron in the diamond lattice. ⁰J. Ruan, K. Kobashi, and W. J. Choyke, Appl. Phys. Lett. 60, 3138 (1992).

During the series of experiments on the effect of methane concentration, one as-grown diamond plate appeared very different from the others. The surface was very similar to that of the results from Bauer et al, who found that by having a misorientation angle of 3-8 degrees from the (100) direction the hillocks did not form on the surface in the same manner as seed crystals that did not have a misorientation angle (less than 1 degree). T. Bauer, M. Schreck, H. Sternschulte, and B. Stritzker, Diamond Relat Mater. 14, 266 (2005). In particular, when the misorientation was measured to be 4.7 degrees, the surface had some hillocks that were greatly elongated on one side. Thus, noting this similarity, the as-grown plate was scanned using the x-ray diffractometer and it was found that this plate had a misorientation angle of 6 degrees. An image of this surface is in FIG. 25. This experiment was repeated with a diamond plate having less than one degree misorientation angle, and it was found that the hillocks did appear more like those found in the other experiments in the series.

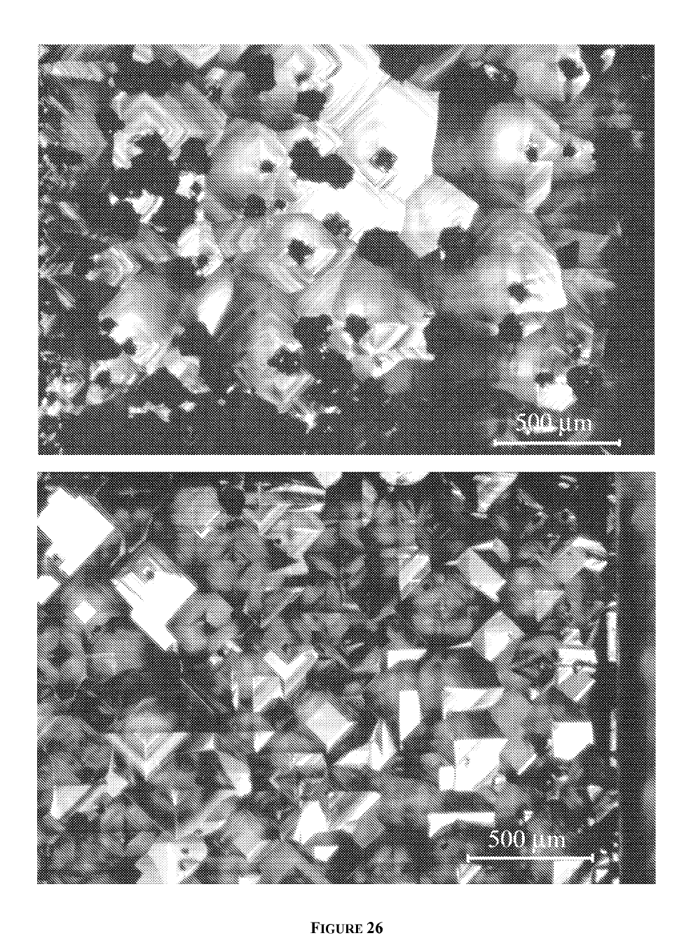

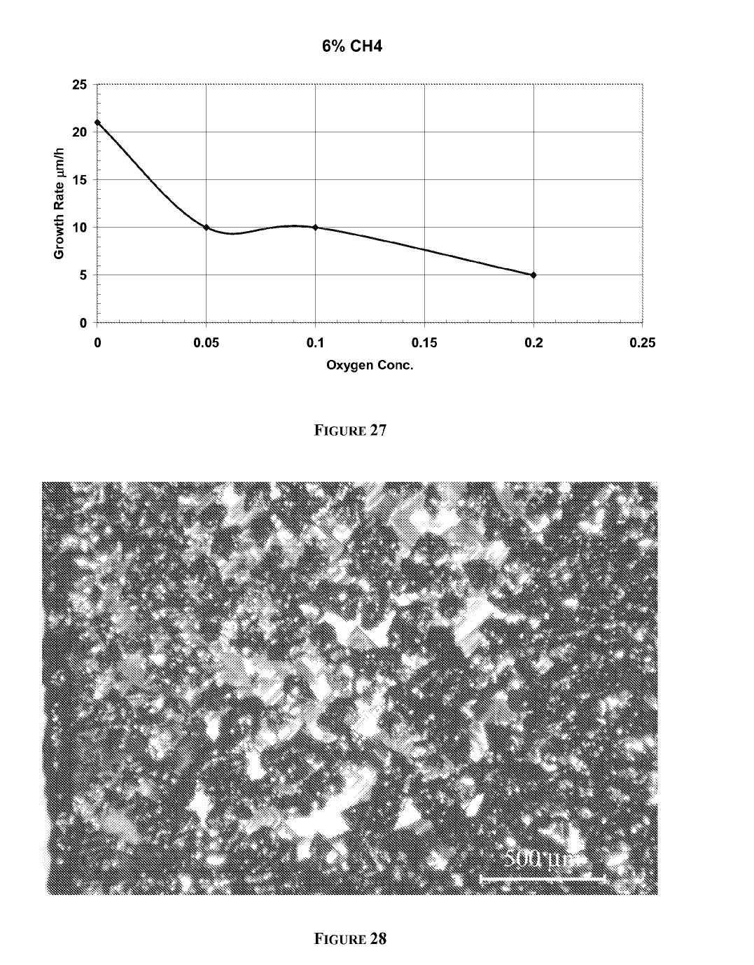

The series of experiments with the effect of varying the oxygen content of the gas mixture revealed that oxygen reduced greatly the presence and size of nonepitaxial crystallites. Sample images contrasting the 0% and 20% oxygen-added depositions are shown in FIG. 26. The growth rate suffered dramatically with the increase in oxygen, as shown in FIG. 27, where the growth rate dropped by a factor of four when 20% oxygen was added as opposed to no oxygen addition. A deposition was performed using high methane (12% CH₄:(H₂+CH₄)) and high oxygen (20% O₂:CH₄). This deposition was meant to test whether the NC's would develop in the high methane concentration with the high oxygen to maintain the surface quality. As can be seen in FIG. 28, the NCs still continue to cover the surface, even though a high concentration of oxygen was used.

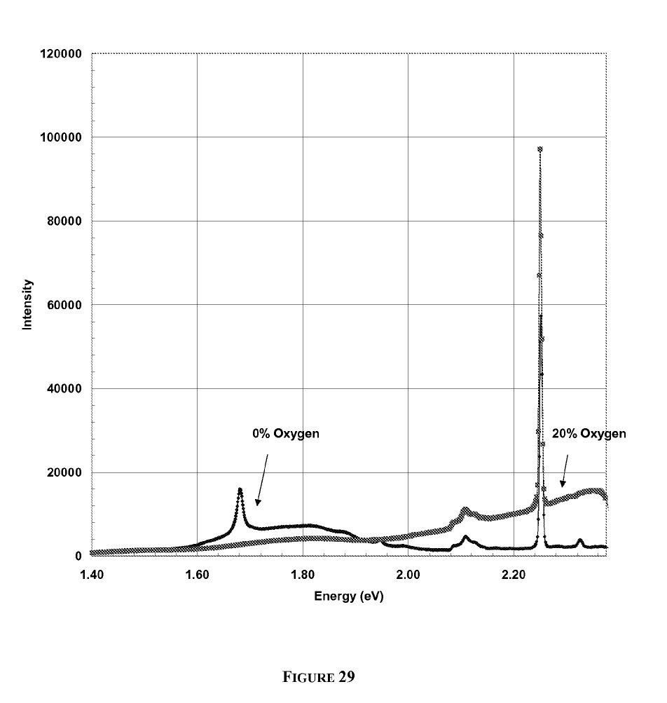

The photoluminescence data for the series on oxygen addition show that the addition of oxygen greatly improves the quality of diamond as evidenced by the reduction of incorporation of optical defect centers. Spectra showing this reduction are in FIG. 29. The clearest reduction of defect centers can be seen in the reduction of the 1.68 eV center, which is the silicon defect center.

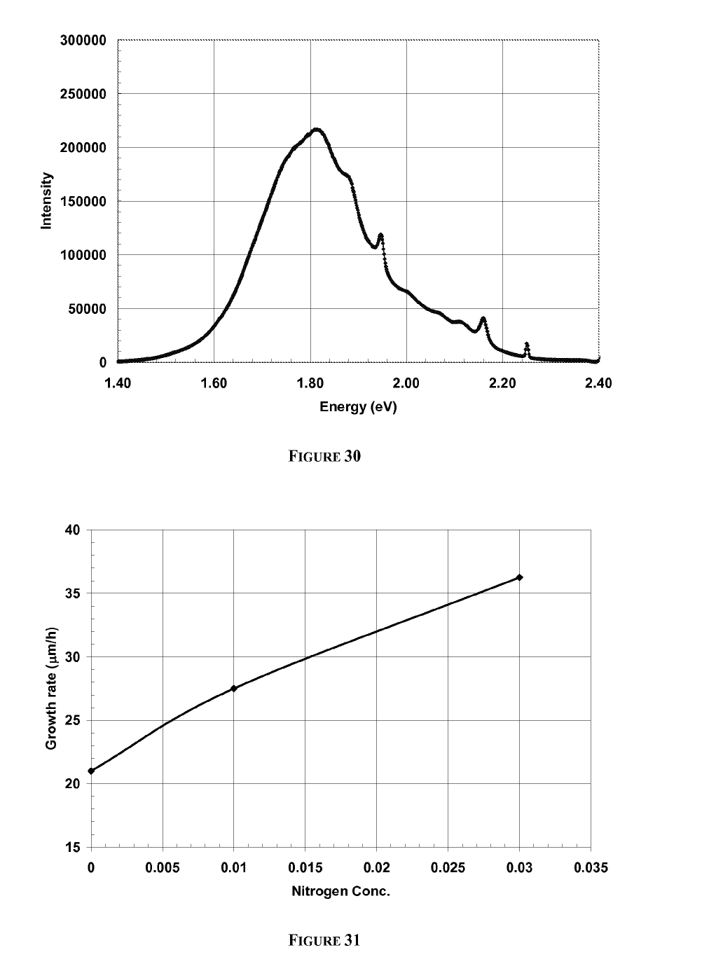

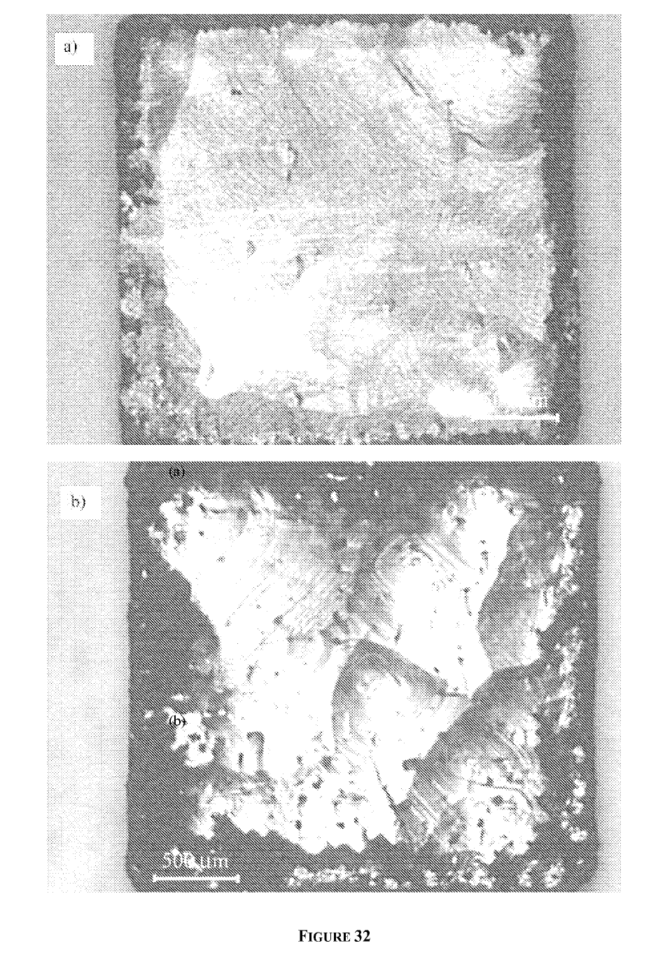

The nitrogen experiments showed a clear difference in the surface morphology. Both the 1% and the 3% nitrogen addition experiments produced the step-flow type of morphology. The increase in nitrogen defects can be seen in FIG. 30, where the N-V₀ and the N-V centers are much greater than the Raman signal. The growth rate almost doubled with the addition of 3% nitrogen. The graph in FIG. 31 shows the growth rate increase with increasing nitrogen addition. The surfaces of these two diamonds can be seen in FIG. 32, where the step-flow pattern is evident. Also noticeable in the image are the outline of some hillocks and the presence of twinned crystals, indicating that these problems are not gone completely.

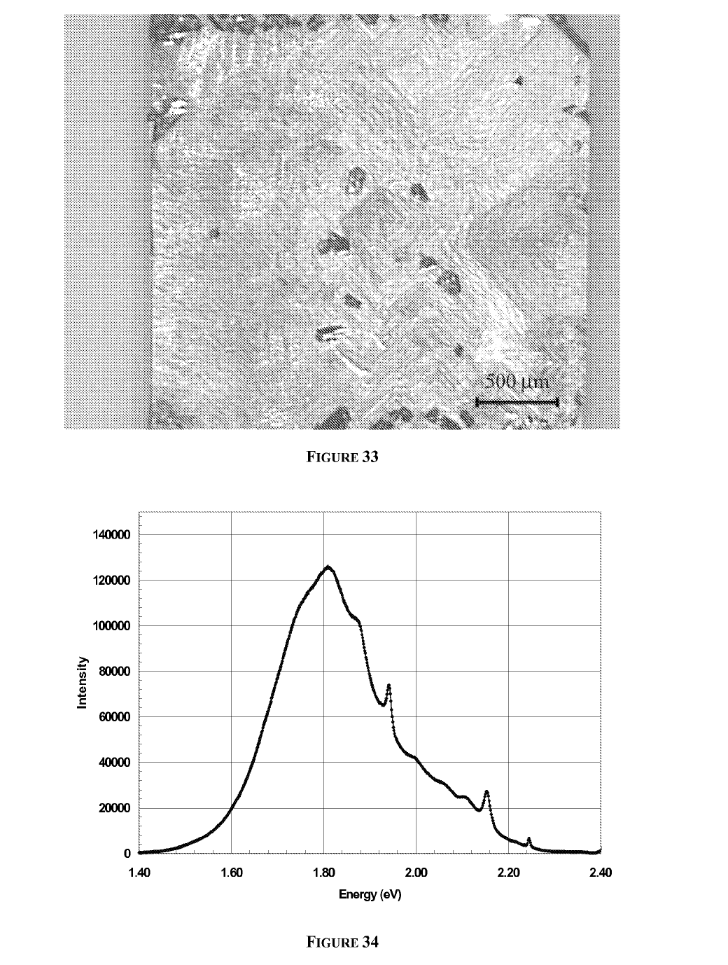

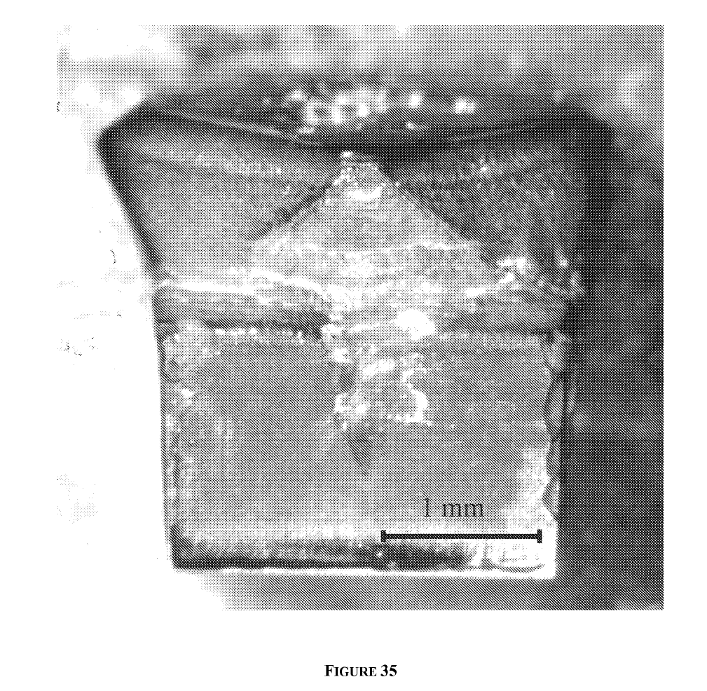

The experiments conducted on the 6 kW CVD system produced very interesting results, mainly, that the higher power density greatly reduced the development of growth hillocks on the surface. The experiment using 6% methane to total gas flow and 1170° C. substrate temperature produced a fairly smooth surface with step-flow type growth. An image of this surface is shown in FIG. 33, where the number of nonepitaxial crystallites is greatly reduced and the hillocks are almost gone. There is an impression of the hillocks but it appears that the fine-structured steps suppressed their growth. The photoluminescence from this surface indicates that there is a large incorporation of nitrogen. Note the similarity in the PL data from the experiments with nitrogen added and the graph from this experiment, which is represented in FIG. 34. This same surface morphology was also found in the 12% methane experiment from the 6 kW CVD system. The sample that was run for 60 hours produced a large growth layer of 1.4 mm. This crystal can be seen in FIG. 35. Note that the grown layer has an orientation of 45 degrees with respect to the plate.

Several samples were chosen for surface analysis on the atomic force microscope. The first sample was the experiment with 6% CH₄:(H₂+CH₄), 10% O₂:CH₄ performed on the 1.2 kW CVD system. This sample was considered to be a standard sample because it represented the “middle of the road” in terms of methane concentration and oxygen addition. The next sample was the highest quality layer, as determined by optical inspection and photoluminescence. This sample was the 6% CH₄:(H₂+CH₄) with 20% O₂:CH₄, also performed on the 1.2 kW CVD system. A nitrogen-added sample was chosen because of its distinct change in morphology; the 3% N₂ sample was used. Lastly, the low temperature (850° C.) sample was chosen because it also had a distinctly different surface morphology.

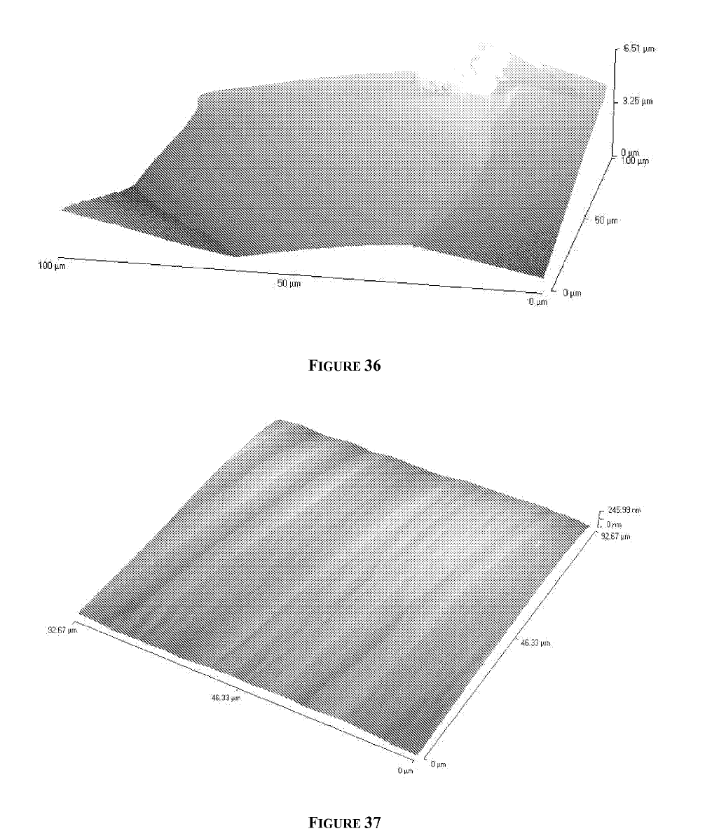

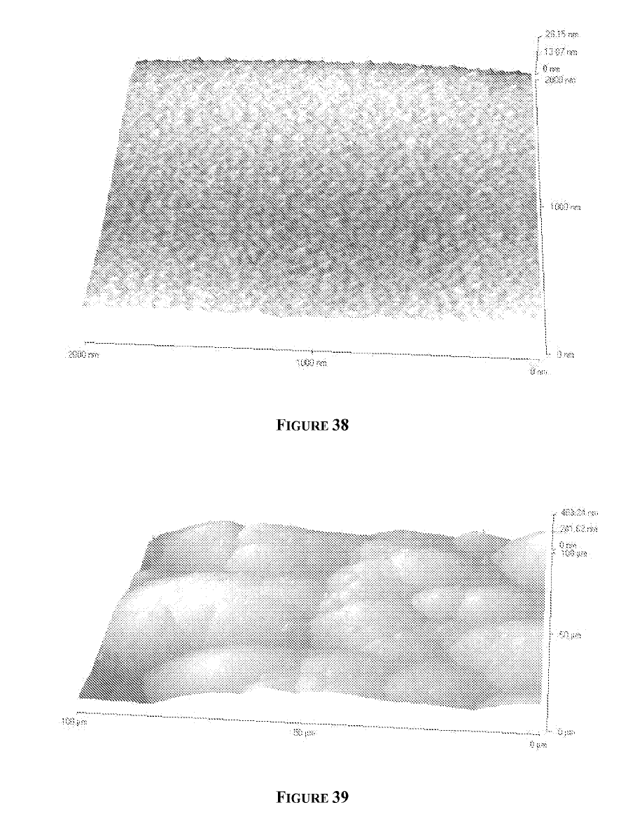

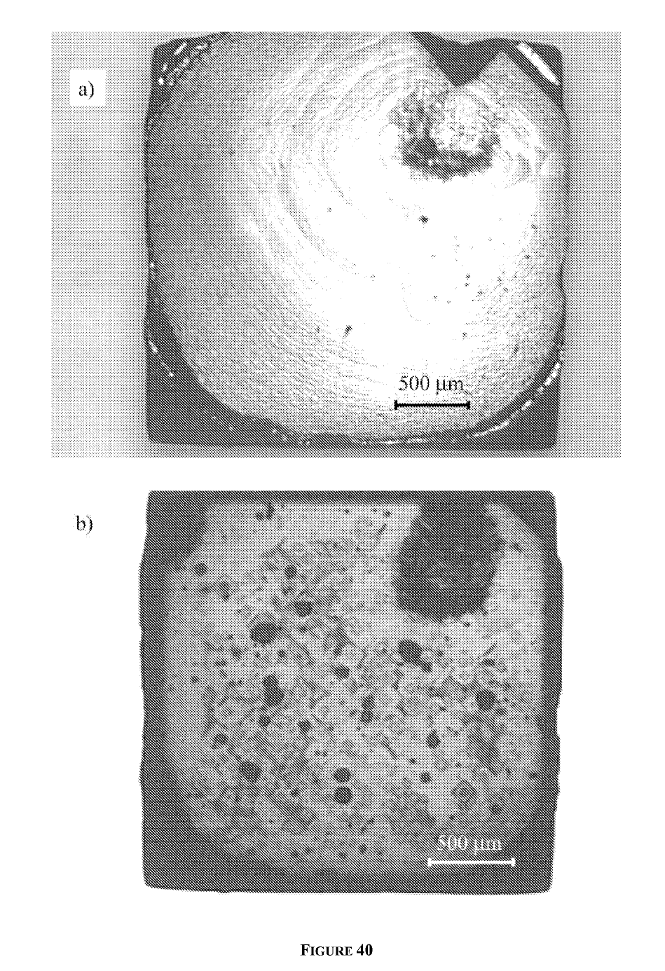

The first sample had several different types of surfaces features that were studied. As seen in FIG. 36 a pyramid with a twin was imaged. Note that the sides of the pyramid are relatively smooth. Also of interest was a smooth region where the total variation in height over a large area (100×100 μm) was less than 250 nm, shown in FIG. 37. The surface roughness from this region was found to be R_{Rms}=19 nm. The surface roughness from the sample with high oxygen addition was found to be only R_{RMS}=0.9 nm. The area analyzed is shown in FIG. 38. The lowest surface roughness was found on the sample that was deposited upon at low temperature. This was found to be only R_{RMS}=0.36 nm. A roughness of Rₐ=0.03 nm has been reported but this was on a surface grown at low pressure (25 Torr) and low methane (0.05%). S. G. Ri, H. Yoshida, S. Yamanaka, H. Watanabe, D. Takeuchi, and H. Okushi, J. Cryst. Growth 235, 300 (2002). Another group reported a value of Rₐ=0.4 nm with a methane concentration of 0.5%. H. Watanabe, D. Takeuchi, S. Yamanaka, H. Okushi, K. Kajimura, and T. Sekiguchi, Diamond Relat. Mater. 8, 1272 (1999). The methods of calculating the roughness are slightly different between Rₐ and R_{RMS}, with the values for Rₐ resulting in a slightly smaller number than R_{RMS}. A low temperature sample is shown in FIG. 39. Note the “bumpy” type of morphology, which does not fall into the categories of step-flow or hillock types of growth.

d. Addition of Nitrogen

The addition of nitrogen was found to suppress hillock formation and induces a completely different growth mechanism. This step-flow growth appears to be more tolerant of surface defects such that a twin or crystallite on the surface will be assimilated into the surrounding homoepitaxial growth and eventually be covered over. This effect can be seen very clearly in one sample with the step-flow morphology in FIG. 40, where image “a” is with reflected light and image “b” is illuminated by transmitted light. These defects appear to have formed somewhere inside the homoepitaxial growth layer but were incorporated by the deposited diamond. In effect, this process is more fault-tolerant than the hillock growth. This tolerance of surface defects may be a reason for the faster growth with the step-flow mechanism.

e. Addition of Oxygen

The addition of oxygen with high methane could produce high growth rate conditions for diamond growth. At low power density, however, the deposited diamond was covered with many crystallites and thus was not high-quality. At high power densities, thick layers could be grown with very low surface defects. In fact, after a period of twelve hours growth the surface achieves a high level of uniformity and appears very smooth to the naked eye. The addition of oxygen was found to affect the growth rate, with high levels diminishing the growth rate considerably.

### 7. CONCLUSIONS

a. Isotopic Enrichment Study

Isotopically enriched diamond layers were grown on natural diamond anvils. The concentration of ¹³C isotope in the layers calculated from the observed frequency of Raman mode is consistent with the isotopic mixture of the methane gas (¹²CH₄ and ¹³CH₄). Low temperature photoluminescence studies clearly establish the nitrogen and silicon based defect centers from the non-(100) diamond surfaces. Polished (100) facets of isotopically enriched diamond show fluorescence levels comparable to original diamond anvil substrates. Atomic Force Microscopy reveals a gradual change in the growth steps from a coarse morphology with a measured surface roughness of few hundred nanometers to atomic level smooth surfaces with a surface roughness of few nanometers. This demonstrates that polished (100) surfaces fluoresce weakly and that isotopically enriched designer diamond anvils with a low concentration of defect centers can be fabricated for high-pressure research. These low fluorescence isotopically enriched designer diamond anvils can prove useful in Raman spectroscopy and photoluminescence spectroscopy on materials at high pressures and high temperatures.

b. Large Area Diamond Growth

Diamond growth by microwave plasma chemical vapor deposition was performed on diamond seed crystals. It was found that the addition of oxygen improved the quality of diamond growth by lowering the incorporation of nitrogen and silicon, as determined by photoluminescence spectrometry. Typically, increasing amounts of oxygen continued to increase the quality of the deposited diamond, but continued to lower the growth rate, indicating that at some level of oxygen addition there would no longer be any growth. This inverse proportion of quality to growth rate can be used for a given set of operating parameters to find a balance, so that an optimum level of oxygen addition can be found. Also, the addition of nitrogen was found to lower the surface defect density but increases the amount of nitrogen incorporated in the diamond. This has the effect of increasing the growth rate and increasing the quality of the growth on a macroscopic level, but lowers the optical quality by incorporating nitrogen as an optical defect center.

A relationship between the nonepitaxial crystallite surface defects and the power density was found: high power density prevents the formation of these crystallites. Also, upon increasing the power density (from 1 to 2.5 kW of microwave power) the growth morphology changed to step-flow. However, the photoluminescence from the deposited diamond showed that there was a large incorporation of nitrogen in the samples from the 6 kW CVD system. This nitrogen incorporation indicates that it can be the cause of the step-flow morphology.

The methane concentration study showed that the growth rate increased linearly with increasing methane concentration, but that it also increased the size of the nonepitaxial crystallites. Also, it was found that the incorporation of impurities did not increase with increasing methane.

The AFM data showed that the surface roughness was low for the sample grown with high oxygen addition but that the lowest roughness value was found on the sample grown at a substrate temperature of 850° C.

The surface morphology was found to have three distinct appearances based on gas chemistry, power density, and substrate temperature. At low temperature, the surface developed a bumpy texture, with some scattered pyramidal structures. These pyramids were different from the hillocks found at high temperature. The samples grown at high temperature were covered with hillocks that had smooth sides with no steps. The addition of nitrogen suppressed these hillocks and formed a surface covered with linear ridges with a shallower height than width. At high temperature and high power density the same morphology occurred with the presence of the hillocks still somewhat visible but with the smooth ridges covering the surface.

The most interesting morphological result was that the step-flow morphology was capable of continuing a homoepitaxial overgrowth even when the surface has nonepitaxial crystallites. This type of growth was useful in growing large crystals up to three millimeters in height.

It was demonstrated that isotopically enriched diamond layers can be deposited on brilliant cut diamond anvils for applications in high pressure research. Isotopically enriched (100) oriented diamond anvil culets can be fabricated with a low concentration of defect centers and these anvils can be utilized in Raman spectroscopy and photoluminescence spectroscopy. The research with homoepitaxial diamond growth on Type Ib diamond plates has demonstrated the need for high power density in the microwave plasma chemical vapor deposition process. The CH₄/H₂/O₂ chemistry was optimized for high growth rate, low nitrogen and silicon contamination as well as low concentration of nonepitaxial diamond crystals. Using the optimized process parameters, a homoepitaxial diamond crystal of 3.0 mm was grown starting from a seed crystal of 1.5 mm in height.

### 8. EXAMPLE 1

A diamond seed crystal measuring 2.5×2.5×1.6 mm³ in size was placed in a molybdenum heat-sinking sample holder in the deposition apparatus. The deposition chamber was filled with hydrogen at 263 sccm (standard cubic centimeters), and a hydrogen plasma was initiated using microwaves from a 2.45 GHz microwave generator. The plasma was maintained until the substrate was close to the deposition temperature. Methane (about 36 sccm) and oxygen (about 1.8 sccm) were turned on, and the system was then allowed to stabilize at a particular temperature and pressure. The pressure used in this example was about 160 Torr. Afterwards, the microwave power and the gas flow rates were manually adjusted to ensure that the substrate was at the desired starting temperature and starting pressure. After this, manual control over the microwave power was turned over to an automated Labview program, which measures the temperature using a non-contact thermometer and varies the power to keep the substrate at the set point temperature of about 1212° C. The power used in this example was about 2.7 kW. Throughout the process, the reflected power was kept low by tuning the microwave cavity. After about 46 hours and 40 minutes, all gases except for the hydrogen were turned off. The Labview control program then lowered over about seven minutes the forward power at a steady rate until the plasma was extinguished. This example produced a diamond with a final size of about 2.5×2.5×3.0 mm³. The diamond was graded to be an “I” in color and having less than about 2 ppm nitrogen content, which is near colorless. The growth rate using these conditions was calculated to be about 30 microns per hour.

### 9. EXAMPLE 2

A diamond seed crystal measuring 2.5×2.5×1.6 mm³ in size can be placed in the molybdenum heat-sinking sample holder of the deposition apparatus. The deposition chamber can be filled with hydrogen at 263 sccm (standard cubic centimeters), and a hydrogen plasma can then be initiated using microwaves from a 2.45 GHz microwave generator. The plasma can be maintained until the substrate is close to the deposition temperature. Methane (about 36 sccm) and oxygen (about 1.9 sccm) can then be turned on, and the system then allowed to stabilize at a particular temperature and pressure. The pressure can be about 160 Torr. Afterwards, the microwave power and the gas flow rates can then be manually adjusted to ensure that the substrate is at the desired starting temperature and starting pressure. After this, manual control over the microwave power can then be turned over to an automated Labview program, which measures the temperature using a non-contact thermometer and varies the power to keep the substrate at the set point temperature of about 1050° C. The power used in this example can be about 1800 W. Throughout the process, the reflected power can be kept low by tuning the microwave cavity. After the desired amount of time, for example, about 40 hours, all gases except for the hydrogen can be turned off. The Labview control program can then lower over a time, for example about seven minutes, the forward power at a steady rate until the plasma becomes extinguished. This example can produce diamond as a brilliant cut stone of 0.5 carat after cutting and polishing, nitrogen level below 1 ppm, white in appearance after thermal annealing. The growth rate using these conditions was calculated to be about 30 microns per hour.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

TABLE 1
Sample designations, geometry, isotopic content, and Raman peak positions for all samples used in this study.

| | Initial Substrate | | | | | | | |
|---|---|---|---|---|---|---|---|---|
| | Geometry Central | ¹³C molar fraction | | Raman Peaks Observed (cm⁻¹) | | | | |
| | Flat-bevel-Culet | Nominal | Empirical | mix | FWHM | natural | FWHM | Comments |
| L162 | 10 μm-10°-300 μm | 0.01 | 0.012 (0.002) | | | 1332.4 (0.2) | 4.0 (0.8) | 10-turn coil used in |
| | | | | | | | | high pressure experiments |
| AIDA-1 | 200 μm-(irregular) | 0.40 | 0.41 (0.01) | 1315.8 (0.04) | 7.3 (0.1) | 1332.6 (0.4) | 3.6 (0.1) | Not polished |
| AIDA-2 | 10 μm-10°-250 μm | 0.80 | 0.83 (0.01) | 1293.2 (0.1) | 9.4 (0.3) | 1332.4 (0.2) | 3.5 (0.1) | Cut to 35 μm-8.5°-350 μm |
| AIDA-3 | 10 μm-20°-450 μm | 1.00 | 0.99 (0.01) | 1281.9 (0.1) | 5.2 (1.7) | 1332.1 (0.2) | 3.6 (0.4) | [111]-oriented cracking |
| | | | | | | | | during polishing |
| AIDA-4 | 35 μm-10°-350 μm | 1.00 | 0.99 (0.01) | 1281.7 (0.5) | 3.6 (0.8) | 1332.7 (0.4) | 4.5 (0.2) | Cut to 100 μm-8.5°-250 μm |
| AIDA-5 | 300 μm-41°-N/A | 1.00 | 1.01 (0.01) | 1279.8 (1) | 4.7 (0.3) | 1331.7 (1) | 5.5 (0.3) | Has been used in over 30 |
| | | | | | | | | high pressure experiments |
| AIDA-6 | 400 μm-41°-N/A | 1.00 | 0.99 (0.01) | 1282 (0.5) | 4.8 (0.2) | | 5.3 (0.3) | Cut to 200 μm flat 12°-300 μm |
| AIDA-7 | 300 μm-41°-N/A | 1.00 | 1.00 (0.01) | 1281 (0.5) | 2.3 (0.2) | | 2.3 (0.2) | Cut to 70 μm-8.5°-300 μm |

TABLE 2
Experiments performed with relevant operating parameters

| | | | | Micro- | |
|---|---|---|---|---|---|
| | Methane | | | wave | |
| Experi- | (of total | Oxygen | Nitrogen | Power | |
| ment | flow) | (O₂: CH₄) | (N₂: CH₄) | (W) | Comment |
| LDP11 | .02 | .10 | 0 | 1100 | Very little growth |
| LDP12 | .04 | .10 | 0 | 1100 | |
| LDP13 | .06 | .10 | 0 | 1100 | Misoriented plate |
| LDP14 | .08 | .10 | 0 | 1100 | |
| LDP15 | .10 | .10 | 0 | 1100 | |
| LDP16 | .12 | .10 | 0 | 1100 | |
| LDP17 | .06 | 0 | 0 | 1100 | |
| LDP18 | .06 | .20 | 0 | 1100 | Fewest NC's |
| LDP19 | .06 | .05 | 0 | 1100 | |
| LDP20 | .06 | 0 | .01 | 1100 | |
| LDP21 | .06 | 0 | .03 | 1100 | |
| LDP22 | .06 | .10 | 0 | 1100 | Repeat of LDP13 |
| LDP23 | .12 | .20 | 0 | 1100 | |
| LDP24 | .06 | .10 | 0 | 1100 | 850 degrees |
| LDP25 | .06 | .10 | 0 | 1100 | 48 hours |
| LDP26 | .06/.12 | .20/.10 | 0 | 1100 | 4 hrs./20 hrs. |
| LDP27 | .06 | .10 | 0 | 1100 | Acid etch pre- |
| | | | | | dep. |
| LDP28 | .06 | .05 | 0 | 2500 | |
| LDP30 | .12 | .05 | 0 | 2500 | 12 hours |
| LDP32 | .12 | .05 | 0 | 2500 | 60 hours |

TABLE 3
Summary of zero phonon lines and phonon sideband energies.

| | Collins et al. [symbol] | L162 | AIDA-1 | AIDA-2 | AIDA-3 | AIDA-4 |
|---|---|---|---|---|---|---|
| ¹³C molar fraction | 1.00 | 0.012 | 0.41 | 0.83 | 0.99 | 0.99 |
| 575 nm-ZPL (meV) | 2159 | 2155.8 (0.1) | 2156.1 | 2155.8 (0.2) | 2159 (1) | 2.158 (3) |
| width | | 2.5 | 3.4 | 2.5 | 6 | 2.4 (0.9) |
| 1st sideband | | 45.3 (3.0) | 44 (1) | 45.4 | 42 (1) | 43.5 (0.4) |
| width | | 18 | 22 | 18.9 | 21 (1) | 22 (2) |
| 640 nm ZPL (meV) | 1947.1 | 1945.4 (0.1) | 1946 (1) | 1945.4 | 1946 (1) | 1945.2 (0.3) |
| width | | 1.7 (0.1) | 3 | 1.8 | 1.8 | 4.0 (0.2) |
| 1st sideband | | 65 (2) | 64 | 64.6 | 64.6 | 62.8 (0.7) |
| width | | 22 (1) | 24 | 22 | 22 | 24 (2) |

[symbol]

indicates data missing or illegible when filed

1. A method of producing high-quality diamond comprising the steps of:
a. providing a mixture comprising:
i. hydrogen,
ii. a carbon precursor, and
iii. oxygen;
b. exposing the mixture to energy at a power sufficient to establish a plasma from the mixture;
c. containing the plasma at a pressure sufficient to maintain the plasma; and
d. depositing carbon-containing species from the plasma to produce diamond at a growth rate of at least about 10 μm/hr;
wherein the diamond comprises less than about 10 ppm nitrogen.

2. The method of claim 1, further comprising an annealing step subsequent to the depositing step.

3. (canceled)

4. The method of claim 1, wherein the carbon-containing species are deposited from the plasma onto a recessed heat-sinking holder.

5-15. (canceled)

16. The method of claim 1, wherein the carbon precursor comprises at least one of methane or acetylene.

17. The method of claim 1, wherein the mixture further comprises a carrier gas.

18. (canceled)

19. The method of claim 1, wherein nitrogen is substantially absent from the mixture.

20-26. (canceled)

27. The method of claim 1, wherein the energy comprises microwaves.

28-38. (canceled)

39. The product produced by the method of claim 1.

40. A composition comprising:
a. hydrogen,
b. a carbon precursor in a concentration of from about 8 vol % to about 16 vol %, and
c. oxygen in a concentration of from about 0.08 vol % to about 3.2 vol %,
wherein the concentration of each component is relative to the total volume of the composition.

41. (canceled)

42. The composition of claim 40, wherein the carbon precursor comprises at least one of methane or acetylene.

43-50. (canceled)

51. The composition of claim 40, further comprising a carrier gas.

52. (canceled)

53. The composition of claim 40, wherein nitrogen is substantially absent from the mixture.

54. A plasma composition comprising:
from about 26.5 mass % to about 44.6 mass % carbon;
from about 0.8 mass % to about 19.6 mass % oxygen; and
from about 43.5 mass % to about 69 mass % hydrogen;
wherein the % mass of each component is relative to the total mass of the composition.

55. The composition of claim 54, wherein the balance of the composition consists essentially of hydrogen.

56. The composition of claim 54, further comprising a carrier.

57. (canceled)

58. The composition of claim 54, wherein nitrogen is substantially absent from the composition.

59-87. (canceled)

88. An apparatus for diamond production in a deposition chamber, comprising:
a. a heat-sinking holder for holding a diamond and for making thermal contact with a side surface of the diamond adjacent to an edge of a growth surface of the diamond, wherein the holder comprises:
i. a surface substantially facing a means for generating plasma, and
ii. a recess disposed within the surface and dimensioned to hold the diamond,
iii. wherein the growth surface of the diamond is positioned below the holder surface;
b. a noncontact temperature measurement device positioned to measure temperature of the diamond across the growth surface of the diamond; and
c. a main process controller for receiving a temperature measurement from the noncontact temperature measurement device and controlling temperature of the growth surface.

89. The apparatus of claim 88, wherein all temperature gradients across the growth surface are less than 50° C.

90. (canceled)

91. The apparatus of claim 88, wherein only a growth surface of the diamond is exposed.

92. The apparatus of claim 88, wherein the heat-sinking holder comprises molybdenum.

93. (canceled)
